(19) United States
(12) Patent Application Publication
(10) Pub. No.: US 2020/0347330 A1
(43) Pub. Date: Nov. 5, 2020

(54) CAFFEINATED ALCOHOLIC COFFEE FRUIT BEVERAGE

(71) Applicants: Brett Elliot Blumstein, Glendale, CA (US); Gilad Rahn, Los Angeles, CA (US)

(72) Inventors: Brett Elliot Blumstein, Glendale, CA (US); Gilad Rahn, Los Angeles, CA (US)

(21) Appl. No.: 16/794,109

(22) Filed: Feb. 18, 2020

Related U.S. Application Data
(63) Continuation-in-part of application No. 16/399,863, filed on Apr. 30, 2019, now abandoned.

(51) Int. Cl. C12G 3/024; C12G 3/026; C12H 6/02; C12G 3/06

(52) U.S. Cl. CPC C12G 3/024; C12G 3/06; C12H 6/02; C12G 3/026

(57) ABSTRACT

A method for producing a caffeinated coffee fruit alcoholic beverage may include some of the following steps: (a) placing an amount of dried coffee fruit, without coffee beans, into an amount of hot water producing a first mixture; (b) steeping the first mixture producing a second mixture with caffeine from the dried coffee fruit; (c) adding in at least one sweetener to the second mixture to produce a third mixture; (d) cooling the third mixture to room temperature producing a fourth mixture; (e) adding at predetermined amount of at least one microbe to the fourth mixture producing a fifth mixture; (f) fermenting the fifth mixture producing a sixth mixture; (g) filtering the sixth mixture producing a seventh mixture; (h) adjusting an ethanol content of the seventh mixture producing an eighth mixture; and (i) carbonating the eighth mixture producing a ninth mixture.

### PRIORITY NOTICE

The present patent application is a continuation-in-part (CIP) of U.S. non-provisional patent application Ser. No. 16/399,863 filed on Apr. 30, 2019, and claims priority to said U.S. non-provisional patent application under 35 U.S.C. § 120. The above-identified patent application is incorporated herein by reference in its entirety as if fully set forth below.

### TECHNICAL FIELD OF THE INVENTION

Embodiments of the present invention may generally relate to caffeinated alcoholic beverages; and more specifically to naturally caffeinated alcoholic and coffee fruit flavored beverages, wherein such beverages may be produced by fermentation of coffee fruit without coffee beans.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Coffee the common beverage, that is the beverage derived from brewing of roasted coffee beans, has and continues to be a popular worldwide beverage. Part of the popularity of coffee the common beverage may be due to the beverage comprising natural caffeine, a human stimulant. Part of the popularity of coffee the common beverage may result from the coffee flavor itself, imparted from the brewing of the roasted coffee beans, a flavor which many are now familiar with and desire. Although without adding some sort of sweetener, unsweetened coffee the common beverage that coffee flavor is actually very bitter, to a point where significant drinkers of coffee the common beverage require addition of some sort of sweetener.

In order to prepare coffee the common beverage, dried roasted coffee beans must be obtained. Coffee beans are derived from the coffee fruit or coffee cherry (or coffee berry). In terms of processing coffee cherries to obtain coffee beans, whether utilizing the “wet method” or the “dry method” (as those terms are used in the industry of producing coffee beans), ultimately the coffee beans are separated from the coffee fruit. The now freed coffee beans may then be dried, roasted, and ground to be used in the brewing of coffee the common beverage. Thus, producing coffees beans for use in preparing coffee the common beverage results in a waste byproduct of largely unwanted coffee fruit, often as a pulp, wherein the coffee beans have been removed and are the generally desired byproduct. There is tremendous demand for coffee beans and in comparison very little demand for coffee fruit that does not include coffee beans. Thus, comparatively, coffee beans cost much more than coffee fruit that does not include coffee beans.

Additionally, coffee the common beverage, in terms of flavor quality and minimization of bitterness, is heavily dependent upon coffee tree (shrub) species, sub-species, varietal, cultivation location, and processing procedures to produce and store dry and/or roasted coffee beans. As a result dry and/or roasted coffee beans from various coffee tree (shrub) species, sub-species, varietal, cultivation locations, and differences in processing vary tremendously in cost. It would be desirable to produce a naturally coffee fruit flavored beverage, that is not dependent or much less dependent upon such variables as coffee tree (shrub) species, sub-species, varietal cultivation locations, and differences in processing—as compared against coffee the common beverage.

Like coffee the common beverage, alcoholic beverages, have and continue to be popular worldwide beverages. Thus, it would be desirable to combine aspects of coffee as the common beverage (e.g., similar natural coffee flavors and/or inclusion of natural caffeine) with alcoholic beverages, to produce a naturally coffee fruit flavored alcoholic beverage that also naturally comprises caffeine. Further, it would be desirable to utilize coffee fruit that does not include coffee beans as a source material for natural coffee fruit flavors and natural caffeine, versus using coffee beans, in part because the coffee fruit that does not include coffee beans may be substantially more affordable than coffee beans to obtain; and/or processing of the coffee fruit to produce an alcoholic beverage may have benefits over utilizing substantially coffee beans to produce an alcoholic beverage. Using coffee fruit flesh, without coffee beans, as a source material for a beverage may result in the resulting beverage having less bitterness as compared against coffee the common the beverage. Using coffee fruit flesh, without coffee beans, as a source material for a beverage may result in the resulting beverage having desirable amounts of caffeine in an alcoholic beverage as compared against using coffee beans for the source material.

Much of the prior art focuses on improving the taste of coffee as the common beverage and thus does not teach any aspects of an alcoholic naturally coffee fruit flavored beverage that may also comprise natural caffeine. For example, prior art does not teach alcohol by volume (ABV) content for any alcoholic naturally coffee fruit flavored beverage.

One U.S. patent may allude to an alcoholic beverage made from freeze-dried coffee (presumably freeze-dried roasted and ground coffee beans) and an expanded ethanol containing powder. That U.S. patent may teach mixing two such powders with hot water to produce a beverage with coffee flavor and some alcohol content. However, relying upon combining dry powders may not be desirable for many large-scale consumer type beverages, wherein it may be desirable to utilize liquids instead of powders, as the final consumable product is indeed liquid. As mixing dry powders with a liquid to produce a consumable beverage is messy, time consuming, and generally inconvenient to the consumer. Further, many consumers would prefer a beverage produced naturally and less dependent upon artificial (non-natural) processing steps, like freeze-drying.

Another U.S. patent may teach fermentation of a coffee substrate to yield a natural coffee flavor (of which diacetyl and acetoin may be such flavor constituents). Such produced diacetyl may be recovered and/or concentrated and added to a coffee product. That U.S. patent is about producing flavors, that might be considered a coffee flavor, for use in products that may desire coffee flavors. This patent does not teach alcohol production by fermentation. That U.S. patent does not teach processes nor compositions of a naturally coffee fruit flavored alcoholic beverage that also naturally comprises caffeine.

Another U.S. patent may teach use of coffee bean waste byproducts for use in other food and beverage products, wherein such waste byproducts may be coffee fruit. A focus of that U.S. patent is more on how the coffee fruit as a waste byproduct may be derived from normal coffee bean processing, and how such a waste byproduct may then be processed to be ready for use in foods and beverages as a general proposition, but with no specific enabling disclosures of specific use in specific foods nor specific beverages. That U.S. patent does not teach processes nor compositions of any beverage, including that of a naturally coffee fruit flavored alcoholic beverage that also naturally comprises caffeine. This patent discloses nothing about fermentation, nor alcoholic beverages.

Another U.S. patent may teach fermentation of green coffee beans (i.e., unroasted coffee beans), as well as the coffee cherry and coffee pulp to obtain desirable coffee flavors. Such obtained flavors, might be coffee flavors, and may be captured and then added to various coffee products. This patent was directed to solving problems of green coffee bean fermentation associated with using microorganism A. oryzae by instead using microorganisms of the genus Geotrichum (such as Geotrichum candidum, Geotrichum rectangulatum, and Geotrichum klebahnii). A purpose of that U.S. patent was not to specifically teach producing beverages, including alcoholic beverages. That U.S. patent does not teach processes nor compositions of a naturally coffee fruit flavored alcoholic beverage that also naturally comprises caffeine.

A U.S. published patent application may teach production of an alcoholic coffee-based beverage, wherein a fermentation process may utilize roasted coffee beans. There is no disclosure nor teaching of fermentation from coffee fruit (cherry, berry, pulp), nor compositions comprising extracts and/or derivatives from coffee fruit (cherry, berry, pulp). As noted in this specification, coffee beans, whether green or roasted, by themselves, are poor substrates for fermentation directed towards alcohol production because coffee beans have little sugar content; and may result in an end product that is too bitter and/or with too much caffeine.

There is a need in the art for a naturally coffee fruit flavored alcoholic beverage that also naturally comprises caffeine. Further, it would be desirable to utilize coffee fruit that does not include coffee beans as a source material for natural coffee fruit flavors and natural caffeine, versus using coffee beans, in part because the coffee fruit that does not include coffee beans may be substantially more affordable than coffee beans, and may result in an end product without excessive bitterness, appropriate sweetness, and appropriate caffeine levels.

It is to these ends that the present invention has been developed.

### BRIEF SUMMARY OF THE INVENTION

To minimize the limitations in the prior art, and to minimize other limitations that will be apparent upon reading and understanding the present specification, the present invention may describe a caffeinated coffee fruit alcoholic beverage and methods for producing the same. In some embodiments, this beverage may comprise natural alcohol in a range of about 1% to about 11% ABV from at least microbial fermentation of dissolved sugar; natural caffeine from maceration, freezing, thawing, and microbial fermentation of coffee fruit flesh; natural coffee fruit flavor from maceration, freezing, thawing, and microbial fermentation of coffee fruit flesh; natural ginger flavor from maceration, freezing, thawing, and microbial fermentation of ginger; dissolved gas at about 1.25 to 3.30 volumes of the dissolved gas; and water. The natural alcohol, the natural caffeine, the natural coffee fruit flavor, the natural ginger flavor, and the dissolved gas (which may also be at least in part naturally produced) may each be dispersed within the water. The methods may comprise use of a mixed microbial culture and a two stage fermentation process.

It is an objective of the present invention to produce a coffee fruit flavored beverage that may not be dependent upon coffee beans for the coffee fruit flavoring.

It is another objective of the present invention to produce a coffee fruit flavored beverage that may derive coffee fruit flavoring from less expensive coffee fruit without coffee beans, versus using more expensive coffee beans.

It is another objective of the present invention to produce a coffee fruit flavored beverage with a uniform coffee fruit flavor profile, regardless of sources ingredients with respect to coffee tree (shrub) species, sub-species, varietal, cultivation location, and differences in processing of the coffee fruit.

It is another objective of the present invention to produce a coffee fruit flavored beverage with a uniform coffee fruit flavor profile and minimal bitterness, regardless of sources ingredients with respect to coffee tree (shrub) species, sub-species, varietal, cultivation location, and differences in processing of the coffee fruit.

It is another objective of the present invention to produce a coffee fruit flavored beverage with a more uniform coffee fruit flavor profile and minimal bitterness, regardless of sources ingredients with respect to coffee tree (shrub) species, sub-species, varietal, cultivation location, and differences in processing of the coffee fruit—as compared against coffee the common beverage, wherein differences in these variables do result in greater differences in flavor profile (and cost).

It is another objective of the present invention to produce a caffeinated alcoholic beverage.

It is another objective of the present invention to produce a caffeinated and coffee fruit flavored alcoholic beverage.

It is another objective of the present invention to produce a caffeinated, carbonated, and coffee fruit flavored alcoholic beverage.

It is another objective of the present invention to produce a caffeinated, carbonated, and coffee and ginger flavored alcoholic beverage.

It is another objective of the present invention to produce a caffeinated, carbonated, coffee, hibiscus, and/or honey flavored alcoholic beverage.

It is another objective of the present invention to produce a beverage comprising natural caffeine.

It is another objective of the present invention to produce a beverage comprising natural coffee fruit flavors, derived from coffee fruit and/or from coffee fruit without coffee beans.

It is another objective of the present invention to produce a beverage comprising natural caffeine, and natural coffee fruit flavors, derived from coffee fruit and/or from coffee fruit without coffee beans.

It is another objective of the present invention to produce an alcoholic beverage from a mixed fermentation, i.e. from microbial cultures comprising two or more different species; wherein one microbe species may predominantly produce alcohol and the other microbe species may produce flavorings, such as, but not limited to, at least some of the natural coffee fruit flavors.

It is another objective of the present invention to produce an alcoholic beverage from a mixed fermentation, i.e., from microbial cultures comprising yeast and bacteria.

It is another objective of the present invention to produce an alcoholic beverage from at least a two stage fermentation process.

It is another objective of the present invention to produce an alcoholic beverage from a single stage fermentation process.

It is another objective of the present invention to produce an alcoholic beverage with at least some natural carbonation derived as a byproduct from at least some of the fermentation.

It is another objective of the present invention to produce an alcoholic beverage comprising natural caffeine, wherein some of the natural caffeine is derived during the fermentation process.

It is another objective of the present invention to produce an alcoholic beverage comprising natural caffeine, wherein some of the natural caffeine is derived during a secondary fermentation process.

It is another objective of the present invention to produce an alcoholic beverage comprising natural caffeine, wherein some of the natural caffeine is derived during a single fermentation process.

It is another objective of the present invention to produce an alcoholic beverage comprising natural caffeine, wherein levels of the natural caffeine are about the same in a liquid as between pre-fermentation and post-fermentation.

It is yet another objective of the present invention to produce an alcoholic beverage utilizing ginger as a source material for the fermentation to assist a ginger beer plant microbial culture.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1A may depict steps in a method for producing a caffeinated coffee fruit alcoholic beverage shown in a flow diagram.

FIG. 1B may depict main steps of a microbial fermentation step of the method shown in a flow diagram.

FIG. 1C may depict primary fermentation steps of the microbial fermentation step of the method shown in a flow diagram.

FIG. 1D may depict secondary fermentation steps of the microbial fermentation step of the method, as well as a decanting step, and a post microbial fermentation step, shown in a flow diagram.

FIG. 1E may depict secondary fermentation steps of the microbial fermentation step of the method, as well as a decanting step, and a post microbial fermentation step, shown in a flow diagram.

FIG. 2 shows at least some steps in a method for producing a caffeinated coffee fruit alcoholic beverage.

### REFERENCE NUMERAL SCHEDULE

100 method for producing a caffeinated coffee fruit alcoholic beverage 100
101 microbial fermentation step(s) 101
103 primary fermentation step(s) 103
105 prepare for primary fermentation 105
107 cool dissolved sugar water 107
109 macerate ginger 109
111 add ginger 111
113 add mixed microbial culture to dissolved sugar water 113
115 primary fermentation of dissolved sugar water and ginger 115
117 check for completion of primary fermentation 117
119 forced primary fermentation stop 119
131 secondary fermentation step(s) 131
133 freeze, thaw, and macerate coffee fruit flesh 133
135 add macerated coffee fruit flesh 135
136 add dried coffee fruit (cascara) 136
137 add mixed microbial culture 137
139 secondary fermentation of macerated coffee fruit flesh 139
141 check for completion of secondary fermentation 141
151 decanting step 151
171 post microbial fermentation processing step(s) 171
200 method of producing a naturally caffeinated alcoholic coffee fruit beverage 200
201 step of placing cascara into hot water 201
203 step of steeping cascara 203
205 step of adding sweetener(s) to cascara mixture 205
207 step of adding natural flavor(s) to cascara mixture 207
209 step of cooling cascara mixture 209
211 step of adding yeast to cascara mixture 211
213 step of fermenting cascara mixture 213
215 step of filtering and/or fining fermented cascara mixture 215
217 step of adjusting alcohol content in fermented cascara mixture 217
219 step of carbonating and/or bottling of fermented cascara mixture 219
221 step of pasteurizing fermented cascara mixture 221

### DETAILED DESCRIPTION OF THE INVENTION

A naturally caffeinated and naturally alcoholic beverage comprising natural flavor extracts, natural flavor derivatives, and/or natural fermentation byproducts from at least fermentation of coffee fruit (e.g., without coffee beans) and methods for making the naturally caffeinated and naturally alcoholic beverage are described and disclosed herein. In some embodiments, the naturally caffeinated and naturally alcoholic beverage may be a “caffeinated coffee fruit alcoholic beverage.”

Note, as used herein, the word, “naturally” and “natural” may denote that ingredients, chemical species, and/or chemical and/or physical properties may be already present in starting ingredients, starting chemical species, and starting products (e.g., natural coffee fruit). In addition, as used herein, the word, “naturally” and “natural” may denote that ingredients, chemical species, and/or chemical and/or physical properties may be produced from metabolic functions of various microbes, e.g., via microbial fermentation. In addition, as used herein, the word, “naturally” and “natural” may denote that ingredients, chemical species, and/or chemical and/or physical properties may be produced (i.e., released and/or extracted) from maceration and/or freezing (and subsequent thawing) processes; wherein the phrasing of “may be produced” as used in this paragraph may mean chemically synthesized within a living cell (e.g. from microbial fermentation), released, and/or extracted.

Note, as used herein, the word, “coffee” when used by itself may be associated with the common beverage brewed from roasted coffee beans. Whereas, “coffee fruit” or “coffee cherry” or “coffee fruit flesh” may be in reference to a fruit of a coffee tree (shrub), wherein the coffee fruit may comprise coffee fruit flesh, that may have surrounded a volume where a coffee bean(s) may have occupied that volume.

In some embodiments, as used herein, the words, “macerate” and/or “maceration” may refer to chopping and/or cutting a botanical element into chunks. In some embodiments, as used herein, the words, “macerate” and/or “maceration” may refer to peeling, then chopping and/or cutting a botanical element into chunks. In some embodiments, as used herein, the words, “macerate” and/or “maceration” may refer to chopping and/or cutting a botanical element into chunks and then soaking said chunks to soften said chunks. In some embodiments, as used herein, the words, “macerate” and/or “maceration” may refer to peeling, then chopping and/or cutting a botanical element into chunks, and then soaking said chunks to soften said chunks. For example, and without limiting the scope of the present invention, with respect to maceration of coffee fruit, this may mean at least cutting and/or chopping the coffee fruit into chunks. For example, and without limiting the scope of the present invention, with respect to maceration of ginger root, this may mean at least peeling and then cutting and/or chopping ginger root into chunks.

It is also important to recall that different structural elements of a given plant have very different properties, i.e., not just limited to the structural differences. For example, the pits (seeds) of most common stone fruits (e.g., peaches, apricots, plums, and the like) may contain dangerous levels of cyanide; whereas, the fruit flesh surrounding such pits is generally edible by humans, once ripe. Similarly, apple seeds are toxic; whereas, apple fruit flesh is generally safe and desirable for humans to ingest. Another example, most parts of potato plants, aside from the tuber, are toxic to human ingestion. Likewise, most parts of tomato plants, aside from the fruit, are toxic to human ingestion.

It is also important to distinguish between the coffee fruit and the coffee bean. There are chemical differences between the coffee fruit and the coffee bean; and such difference results in structural differences between the coffee fruit and the coffee bean. The coffee fruit, without the coffee bean, is soft, pliable, and readily mashable. Whereas, the coffee bean, as a seed, is comparatively hard and firm. For example, the coffee beans, including the so called, “green coffee beans” (unroasted coffee beans) are much harder in comparison to the surrounding coffee fruit that may house the coffee beans. For example, animals ingesting the mildly sweet coffee fruit, with coffee beans, generally, pass substantially only the hard and intact coffee beans in their feces, but may absorb and metabolize much of the eaten coffee fruit flesh. The hardness of the coffee bean as compared against the coffee fruit means different and generally more robust equipment is needed to process coffee beans as compared to the coffee fruit. For example, coffee beans are ground; while coffee fruit may be macerated. Additionally, the coffee fruit includes a much greater concentration of sugars as compared to the coffee bean, which may be important in fermentation reactions that benefit from sugar as a source material to feed the fermentation; and particularly where such fermentation may be directed at producing alcohol. Coffee beans are a poor candidate to produce alcohol by fermentation because of their low sugar content. Likewise, the coffee bean may comprise greater concentrations of caffeine as compared against a similar mass of coffee fruit without the coffee beans.

Similarly, differences between coffee bean roasting, coffee bean brewing, and coffee fruit fermentation (e.g., microbial fermentation) may be important. For example, coffee bean roasting, via application of dry heat, may result in various chemical reactions where one chemical species is changed into another chemical species, i.e., chemical reactions driven by heat, which e.g., may produce flavors associated with burning or roasting, which tend to be very strong and rich flavors. Whereas, coffee bean brewing may not involve chemical reactions, but rather use of a warm or hot solvent (i.e., water) to extract compounds chemically produced in the roasting phase. And as compared against fermentation, fermentation is a family of specific chemical reactions; thus, completely different than the non-chemical reaction of solvent extraction seen in coffee bean brewing. And the chemical reactions of fermentation are also very different than the chemical reactions of roasting. For example, roasting does not produce alcohols, like ethanol. And microbial fermentation refers to fermentation, metabolic reactions, occurring within living cells.

From product development and taste testing, the caffeinated coffee fruit alcoholic beverage, without using coffee beans as source material, as compared against coffee the common beverage has a much lighter flavor, a less bitter flavor, a fruitier flavor, a sweeter flavor, and an odor that is much lighter than coffee than common beverage, as well as lightly fruity. Whereas, if coffee beans are used as source material in fermentation, a resulting end product has been found to be too bitter and with an unexpected unpleasant odor, as well as with too much caffeine. Thus when referring to “natural coffee flavor” one must be careful to distinguish whether that natural coffee flavor is obtained from coffee fruit without coffee beans or obtained from coffee beans, as the resulting flavors are very different; which then must be due to different chemical species found in or obtained from coffee fruit without coffee beans versus different chemical species found in or obtained from coffee beans.

Additionally, such testing has also determined that the caffeinated coffee fruit alcoholic beverage, without using coffee beans as source materials, is more conducive to picking up other flavors added and/or mixed into the resulting beverage.

Prior to any taste testing, it was expected that resulting beverages derived from fermenting coffee fruit, without coffee beans, would result in a beverage with flavor profile and odors very similar to coffee the common beverage; however, these beverages were tasted there was the unexpected results that the coffee fruit flavor in the resulting beverage was unlike coffee the common beverage flavors; and there were the unexpected results of the odors from the resulting beverage being unlike that of coffee the common beverage.

It should also be noted that various embodiments of the “caffeinated coffee fruit alcoholic beverage” do not naturally exist in nature. For example, a beverage is a liquid by nature and the coffee fruit is a solid. For example, coffee fruit does not naturally exist in nature with alcohol in a range of about 1% to 11% ABV (alcohol by volume). Nor does the coffee fruit exist naturally in nature with carbonation present in the coffee fruit. For example, compositionally, caffeinated coffee fruit alcoholic beverage may comprise water, sugar (at least some of which may be derived from coffee fruit), natural coffee fruit flavor, alcohol (e.g., in a range of about 1% to 11% ABV), caffeine; and additionally, in some embodiments, also may comprise natural ginger root flavor and/or carbonation; wherein such combinations of chemical species do not exist together in nature.

In some exemplary embodiments, the caffeinated coffee fruit alcoholic beverage may comprise alcohol, caffeine, natural coffee fruit flavor, a liquid carrier, and the like. In some embodiments, the alcohol, the caffeine, and the natural coffee fruit flavor may each be dispersed and/or in solution within the liquid carrier. By weight and/or by volume, the liquid carrier may be a predominant species of the caffeinated coffee fruit alcoholic beverage.

In some embodiments, the alcohol, the caffeine, the natural coffee fruit flavor, and/or the liquid carrier may be each a primary ingredient. That is, in some embodiments, the primary ingredients may be selected from one or more of the group comprising: the alcohol, the caffeine, the natural coffee fruit flavor, the liquid carrier and the like.

In some embodiments, the alcohol, the caffeine, and/or the natural coffee fruit flavor may each be naturally produced from a microbial cellular process, specifically a microbial fermentation process.

In some embodiments, the alcohol may be substantially ethanol. Ethanol may have a chemical formula of C2H6O and a molecular weight of 46.0684 grams (g) per mole (mol). Ethanol may also be known as ethyl alcohol, grain alcohol. Use of “substantially” in the first sentence of this paragraph may denote that there may be alcohols other than ethanol that may also be naturally produced from the microbial fermentation process. For example, and without limiting the scope of the present invention, such other alcohols may be higher fusel alcohols, that may be produced in trace amounts. But in exemplary embodiments, ethanol may be the predominant alcohol species that comprises the alcohol in the caffeinated coffee fruit alcoholic beverage.

In some embodiments, the alcohol produced and/or present in the caffeinated coffee fruit alcoholic beverage may be present in a range of about 1% to 11% ABV (alcohol by volume). In some exemplary embodiments, the alcohol produced and/or present in the caffeinated coffee fruit alcoholic beverage may be present in a range of about 3% to 6% ABV. In some exemplary embodiments, the alcohol produced and/or present in the caffeinated coffee fruit alcoholic beverage may be present in a range of about 6% to 9% ABV. In some exemplary embodiments, the alcohol produced and/or present in the caffeinated coffee fruit alcoholic beverage may be present at about 5% ABV. For example, and without limiting the scope of the present invention, when the alcohol may be present at about 5% ABV, the liquid carrier may be present at about 93% by volume, and a remaining about 2% by volume may comprise flavor components (e.g., natural coffee fruit flavor), extracts, caffeine, and/or the like. Where, “about” in this paragraph may be plus or minus 0.5%.

Note, unless otherwise explicitly stated, the word, “about” when used in connection with ranges and/or specific quantitative units, may be mean a precision of plus or minus 0.1 with respect to the unit in question.

In some exemplary embodiments, the liquid carrier may act as a carrier for at least one of the other primary ingredients. In some exemplary embodiments, the liquid carrier may be substantially water. In some embodiments, the liquid carrier (e.g., water) may be a solvent for at least one of the other primary ingredients. For example, and without limiting the scope of the present invention, at room temperatures, caffeine may be moderately soluble in water at about 2 g of caffeine per 100 milliliters (mL) of water.

Chemically, caffeine may an alkaloid, i.e., a nitrogen-containing substance. Caffeine may have a chemical formula of C8H10N4O2, with a molecular weight of 194.19 g/mol. Caffeine may be a central nervous system stimulant in mammals, including humans, having effects of temporarily warding off drowsiness, restoring alertness and relaxing muscles. Caffeine may naturally occur in at least sixty varieties of plants, with notable examples including the coffee plant, tea tree, yerba mate, guarana berries, cocoa, kola nut, and Yaupon Holly. In plants, caffeine may be present in the leaves, fruit, and/or beans (seeds); however, caffeine levels (concentration) may not be uniform in such different botanical structures. Caffeine presence in beverages that do not substantially contain coffee or tea, is generally added to such beverages as an ingredient during compounding of the specific beverage in question, wherein such caffeine has been industrially solvent extracted from various plants which do naturally have caffeine, purified, dried, and concentrated. Whereas, caffeine presence in coffee and tea drinks may be present, at least in part, naturally from the coffee plant or tea plant.

In some embodiments, a source material for microbial fermentation may be coffee fruit flesh (e.g., without coffee beans). Coffee fruit flesh may be the fruit of the coffee trees and/or shrubs, e.g., of the Coffea arabica and/or Coffea robusta (Coffea canephora) varieties, and/or the like. In some embodiments, coffee fruit from Coffea arabica may be preferred over coffee fruit from Coffea robusta.

Note, as a beverage ingredient and/or as a beverage source material ingredient, coffee fruit flesh (e.g., without coffee beans) is presently an uncommon and unusual ingredient, as noted above, the coffee fruit flesh (e.g., without coffee beans) is presently significantly a waste byproduct from obtaining coffee beans. For example, there may be thousands and tens of thousands of food and beverage products that may comprise sucrose and/or high fructose corn syrup—common ingredients; and only a handful of beverages, if any, which may comprise coffee fruit flesh. And there may be no alcoholic beverages derived from coffee fruit flesh.

In addition to the coffee fruit flesh (e.g., without coffee beans) being presently an uncommon and unusual ingredient, use of coffee fruit flesh (e.g., without coffee beans) in some of the various embodiments of the present invention results in unexpected results, in that regardless of coffee fruit source as Coffea arabica, Coffea robusta (Coffea canephora), or a hybrid thereof, a resulting flavor of the caffeinated coffee fruit alcoholic beverage may be uniform with negligible differences in taste. This is a completely different result as compared with coffee the common beverage. Additionally, regardless of cultivation location, the resulting flavor of the caffeinated coffee fruit alcoholic beverage may be uniform with negligible differences in taste. Again, this is a completely different result as compared with coffee the common beverage. Additionally, regardless of coffee bean processing (e.g., wet or dry), the resulting flavor of the caffeinated coffee fruit alcoholic beverage may be uniform with negligible differences in taste. Again, this is a completely different result as compared with coffee the common beverage. These unexpected results may be because the process of roasting coffee beans that is employed to produce coffee the common beverage, tends to result in rich, strong, powerful, and deep flavors, that may amplify otherwise subtle differences the result from differences: in species, sub-species, varietal, cultivation location, cultivation technique, and/or coffee bean post cultivation processing (e.g., via the wet or the dry method); whereas, fermentation of coffee fruit may not amplify these otherwise subtle differences, such that a uniform tasting beverage results that is far less sensitive to such differences as compared against coffee the common beverage.

In some embodiments, the natural coffee fruit flavor may be a natural fermentation byproduct from the microbial fermentation process of coffee fruit flesh without coffee beans, coffee fruit with coffee beans, and/or of coffee beans alone. In some embodiments, the natural coffee fruit flavor may be a natural released byproduct from a maceration process of coffee fruit flesh without coffee beans, coffee fruit with coffee beans, and/or of coffee beans alone. In some embodiments, the natural coffee fruit flavor may be a natural released byproduct from a freezing process of coffee fruit flesh without coffee beans, coffee fruit with coffee beans, and/or of coffee beans alone. In some embodiments, the natural coffee fruit flavor may be a natural released byproduct from a freezing and maceration process of coffee fruit flesh without coffee beans, coffee fruit flesh with coffee beans, and/or of coffee beans alone. In some embodiments, freezing and/or maceration of coffee fruit flesh without coffee beans, coffee fruit flesh with coffee beans, and/or coffee beans may precede some or all of the microbial fermentation process.

In some embodiments, the natural coffee fruit flavor may be a flavor that a drinker might characterize as tasting and/or smelling of coffee fruit—but not tasting and/or smelling like coffee the common beverage—wherein that natural coffee fruit flavor may be derived, at least in part, from the coffee fruit pulp as source material for the fermentation. In some embodiments, the natural coffee fruit flavor may be a natural fermentation byproduct from the microbial fermentation process of coffee fruit flesh without coffee beans. In some embodiments, the natural coffee fruit flavor may be a natural released byproduct from a maceration process of coffee fruit flesh without coffee beans. In some embodiments, the natural coffee fruit flavor may be a natural released byproduct from a freezing process of coffee fruit flesh without coffee beans. In some embodiments, the natural coffee fruit flavor may be a natural released byproduct from a freezing and maceration process of coffee fruit flesh without coffee beans. In some embodiments, freezing and/or maceration of coffee fruit flesh without coffee beans may precede some or all of the microbial fermentation process. In some embodiments, freezing and maceration of coffee fruit without coffee beans may produce at least some of the natural coffee fruit flavor; and microbial fermentation of the previously frozen and macerated coffee fruit flesh without coffee beans may result in further natural coffee fruit flavor.

In some embodiments, the natural fermentation byproduct and the natural released byproduct may be a same or substantially similar byproduct. In some embodiments, the natural fermentation byproduct and the natural released byproduct may be different chemical species, but with each imparting natural coffee fruit flavors. In some embodiments, natural fermentation byproduct may be a byproduct chemically synthesized by microbes performing fermentation; whereas, the natural released byproduct may be a chemical species already present before fermentation, but released by the maceration, freezing, and/or fermentation processes. Such release may lead to extraction of the byproduct into the liquid carrier.

In some embodiments, the caffeinated coffee fruit alcoholic beverage may comprise a pH range of about 2 to 5. In some embodiments, the caffeinated coffee fruit alcoholic beverage may comprise a pH range of about 3.1 to 3.6. In some embodiments, during the microbial fermentation process the pH may be about 3.2. During the microbial fermentation process pH may be controlled by increasing or decreasing presence of oxygen in a fermentation vessel. Increasing oxygen may lower pH, i.e., increase acidity; whereas, decreasing oxygen levels may increase pH (lower acidity). A generally acidic pH (e.g. less than pH 7) may mitigate against spoilage, as many microbes associated with spoilage prefer a higher pH than fermentation microbes. A generally acidic pH (e.g., a range of 3.1 to 3.6) may be associated with pleasant flavor profiles of alcoholic beverages (e.g., many wines and beers).

In some embodiments, the caffeinated coffee fruit alcoholic beverage may comprise a final gravity (terminal gravity) range of about 1.000 to 1.012; wherein “about” here may indicate plus or minus 0.001. In some embodiments, the caffeinated coffee fruit alcoholic beverage may comprise a final gravity (terminal gravity) of about 1.003; wherein “about” here may indicate plus or minus 0.002.

In some embodiments, the caffeinated coffee fruit alcoholic beverage may comprise a final gravity (terminal gravity) of about 1.786; wherein “about” here may indicate plus or minus 0.100. In some embodiments, an original gravity may be about 1.842; wherein “about” here may indicate plus or minus 0.100.

Measurements of final gravity (terminal gravity) may indicate when fermentation may be complete, sufficiently complete (near complete), or incomplete. Measurements of final gravity (terminal gravity) may indicate sugar density within the caffeinated coffee fruit alcoholic beverage. For example, and without limiting the scope of the present invention, final gravity (terminal gravity) measurements of at about 1.012 may indicate a sweet beverage. For example, and without limiting the scope of the present invention, final gravity (terminal gravity) measurements of above 1.024 may indicate cloying (unpleasantly sweet). For example, and without limiting the scope of the present invention, final gravity (terminal gravity) measurements of below 1.012 may indicate a dry beverage. For example, and without limiting the scope of the present invention, final gravity (terminal gravity) measurements of below 1.000 may indicate an ultra-dry and sour beverage.

In some embodiments, the caffeinated coffee fruit alcoholic beverage may comprise a viscosity (dynamic viscosity or absolute) range of about 1.000 to 4.000 millipascal seconds (mPas) at 20 degrees Celsius (centigrade), wherein “about” here may indicate plus or minus 0.001. In some embodiments, the caffeinated coffee fruit alcoholic beverage may comprise a viscosity range of about 1.700 to 2.140 mPas at 20 degrees Celsius (centigrade), wherein “about” here may indicate plus or minus 0.001.

In some embodiments, the caffeinated coffee fruit alcoholic beverage may comprise at least one secondary ingredient. In some embodiments, the secondary ingredient may be selected from one or more of the group comprising: an additional flavor, a gas, a dissolved gas, a sweetener, a preservative, a stabilizer, a colorant, a pH adjusting species, and/or the like.

In some embodiments, in addition to the natural coffee fruit flavor, the caffeinated coffee fruit alcoholic beverage may comprise a ginger flavor. In some embodiments, the ginger flavor may be a primary ingredient; whereas, in some embodiments, the ginger flavor may be a secondary ingredient. In some embodiments, the ginger flavor may be natural. In some embodiments, the ginger flavor may be imparted from ginger root. In some embodiments, in addition to the natural coffee fruit flavor, the caffeinated coffee fruit alcoholic beverage may comprise a natural ginger flavor. In some embodiments, the natural ginger flavor may be derived from ginger root.

In some embodiments, at least some of the natural ginger flavor may be naturally produced from the maceration, freezing, and/or microbial fermentation processes of the ginger root.

For example, and without limiting the scope of the present invention, in embodiments which may use ginger beer plant (GBP) for at least a portion of the microbial culture used in the microbial fermentation, the natural ginger flavor (e.g., from the ginger root) may be a primary ingredient, prepared similarly (macerated and/or frozen) and introduced similarly as the macerated and previously frozen coffee fruit flesh. Although, in some embodiments, such ginger root may be introduced prior to introducing the coffee fruit flesh. Inclusion of ginger root in embodiments utilizing GBP may improve the fermentation, such as by resulting in a GBP with greater vitality; which for example, is more likely to quickly grow and complete fermentation.

GBP may comprise yeast Saccharomyces florentinus (formerly S. pyriformis), and bacterium Lactobacillus hilgardii (formerly Brevibacterium vermiforme). GBP may form a symbiotic colony of bacteria and yeast. GBP may form a gelatinous culture that may allow the culture to be readily transferred from one fermenting substrate to the next, much like kefir grains, kombucha, and tibicos.

In some embodiments, the additional flavor may be selected from at least one botanical element. Botanical elements may be selected from all or a portion of a plant, including trees, shrubs, vines, creepers, grasses, ground covers, succulents, and/or the like. Botanical elements may be selected from all or a portion of one or more of the group comprising: a fruit, a vegetable, a nut, a bean, a spice, a herb, a flower, a root, a rhizoid, a tuber, a leave, a stem, a branch, bark, and/or the like. Natural flavors derived from such botanical elements may be imparted to the caffeinated coffee fruit alcoholic beverage in similar methods as the natural coffee fruit flavor and/or the ginger flavor. Natural flavors derived from such botanical elements may be imparted to the caffeinated coffee fruit alcoholic beverage by freezing, maceration, and/or microbial fermentation.

For example, and without limiting the scope of the present invention, in some embodiments, the additional flavor may comprise a hazelnut flavor, a citrus flavor, a mint flavor, and/or the like.

In some embodiments, the dissolved gas may be substantially carbon dioxide (CO2), substantially nitrogen (N2), and/or combinations thereof. In some embodiments, headspace in a sealed vessel comprising the caffeinated coffee fruit alcoholic beverage may be substantially carbon dioxide (CO2), substantially nitrogen (N2), and/or combinations thereof. In some embodiments, the dissolved gas may be imparted to caffeinated coffee fruit alcoholic beverage, naturally (e.g., production of CO2 as a metabolic microbial fermentation byproduct), forced (e.g., pumped into the beverage under pressure), or both naturally and forced.

In some embodiments of the caffeinated coffee fruit alcoholic beverage, at least some of the CO2 may be naturally produced from the microbial fermentation process.

In some embodiments, the dissolved gas or at least some of the dissolved gas may be introduced into the caffeinated coffee fruit alcoholic beverage by pumping a quantity of the dissolved gas into the caffeinated coffee fruit alcoholic beverage when the caffeinated coffee fruit alcoholic beverage is contained within a vessel sealed to an external environment. Pumping dissolved gas into the caffeinated coffee fruit alcoholic beverage solution may be an example of forced carbonation. In some embodiments, forced carbonation may follow post-fermentation processes, such as post-fermentation filtering and post-fermentation processing, which may include steps of flavor balancing, including preservatives, stabilizers, colorants, pH adjusting species, other secondary ingredients, and/or the like.

In some embodiments, the dissolved gas may be present in a range of about 1.25 to 3.30 volumes of CO2. In some embodiments, the dissolved gas may be present in a range of about 2 to 3 volumes of CO2. Such volumes of CO2 may define the quantity of CO2 pumped into the caffeinated coffee fruit alcoholic beverage solution, in embodiments utilizing forced carbonation.

In some embodiments, the sweetener may be a primary ingredient and/or a secondary ingredient. For example, and without limiting the scope of the present invention, in some embodiments, the sweetener, such as a sugar (e.g., cane sugar), may be used to start the microbial fermentation process; wherein upon fermentation completion there may be some residual sugar, which may be important for balance (i.e., flavor balance). Additionally, in some embodiments, post fermentation, secondary ingredient sweeteners may be added for balance.

In some embodiments, the sweetener may be selected from one or more of the group comprising: sugar, natural sweeteners, novel sweeteners, sugar alcohols, artificial sweeteners, and/or the like.

In some embodiments, the sugar may be selected from one or more of the group comprising: cane sugar, sucrose, dextrose, maltose, lactose, glucose, fructose, and high fructose corn syrup (HFCS), honey (such as, but not limited to, wild flower honey), combinations thereof, and/or the like. Cane sugar may be substantially sucrose.

In some embodiments, the natural sweetener may be selected from one or more of the group comprising: agave nectar, date sugar, fruit juice, fruit juice concentrate, honey, maple syrup, molasses, and/or the like.

In some embodiments, the novel sweetener may be selected from one or more of the group comprising: stevia extracts, tagatose, trehalose, and/or the like.

In some embodiments, the sugar alcohol may be selected from one or more of the group comprising: erythritol, isomalt, lactitol, maltitol, mannitol, sorbitol, xylitol, and/or the like.

In some embodiments, the artificial sweetener may be selected from one or more of the group comprising: acesulfame, aspartame, neotame, saccharin, sucralose, advantame, and/or the like.

In some embodiments, the amount of the sweetener may vary by the type and/or combination of sweeteners, but may be amount(s) that avoid a cloying beverage (unpleasantly sweet).

In some embodiments, the caffeinated coffee fruit alcoholic beverage may comprise one or more preservatives. In some embodiments, the caffeinated coffee fruit alcoholic beverage may comprise one or more antioxidants. In some embodiments, the one or more preservatives may be selected from the group comprising: potassium sorbate, sorbic acid, sulfur dioxide, potassium metabisulphite, ascorbic acid, sulfites, sulfur based preservatives, DMDC (dimethyl decarbonate), combinations thereof, and/or the like.

In some embodiments, the caffeinated coffee fruit alcoholic beverage may comprise one or more stabilizers. Some stabilizers (e.g., potassium sorbate and potassium metabisulphite) may prevent or minimize re-fermentation of residual sugars and carbohydrates. In some embodiments, the stabilizer may also be a preservative and/or antioxidant. For example, and without limiting the scope of the present invention, in some embodiments, the stabilizer and the preservative may be potassium sorbate. In some embodiments, the stabilizer may be sodium benzoate. In some embodiments, stabilizers may bind undesirable flavor compounds (e.g., some polyphenols) and the subsequent bound complex may then be filtered to remove the bound complex. For example, and without limiting the scope of the present invention, in some embodiments, the stabilizer may be POLYCLAR available from Ashland.

In some embodiments, the caffeinated coffee fruit alcoholic beverage may comprise one or more colorants. In some embodiments, the colorant may be a natural colorant and/or an artificial colorant. In some embodiments, the natural colorant may be derived from the natural coffee fruit flavor, the ginger flavor, and/or other botanical elements providing additional (natural) flavors. In some embodiments, the botanical elements may be selected from all or a portion of one or more of the group comprising: a fruit, a vegetable, a nut, a bean, a spice, a herb, a flower, a root, a rhizoid, a tuber, a leave, a stem, a branch, bark, and the like.

In some embodiments, the caffeinated coffee fruit alcoholic beverage may comprise one or more pH adjusting species, to adjust the pH to a desirable level. In some embodiments, the caffeinated coffee fruit alcoholic beverage may comprise a pH range of about 2 to 5. In some embodiments, the caffeinated coffee fruit alcoholic beverage may comprise a pH range of about 3.1 to 3.6. In some embodiments, the pH adjusting species may be an acid and/or dissolved carbon dioxide. In some embodiments, the acid may be one or more of lactic acid, tartaric acid, citric acid, and/or the like.

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

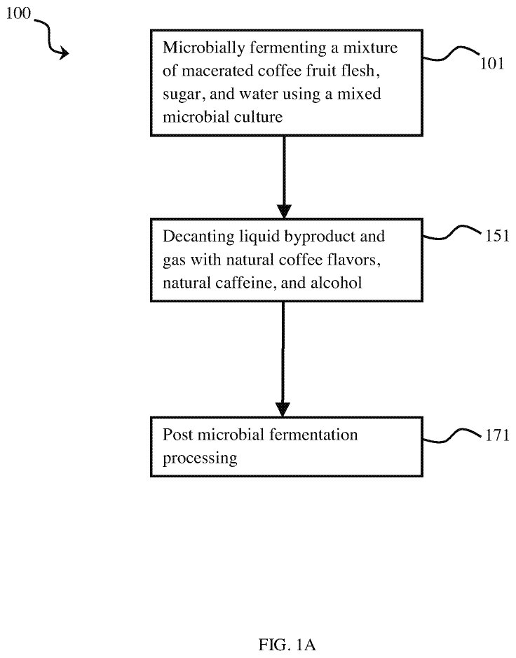

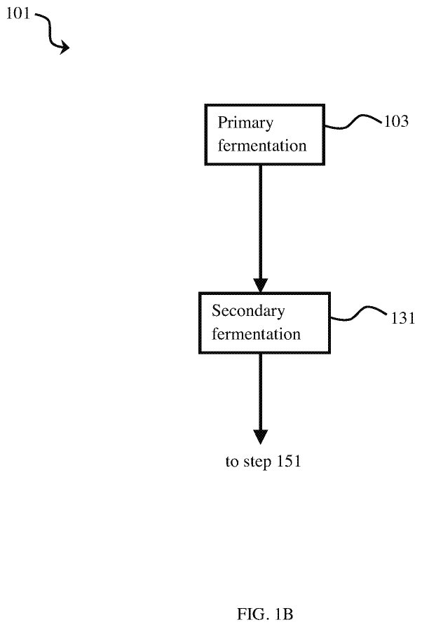

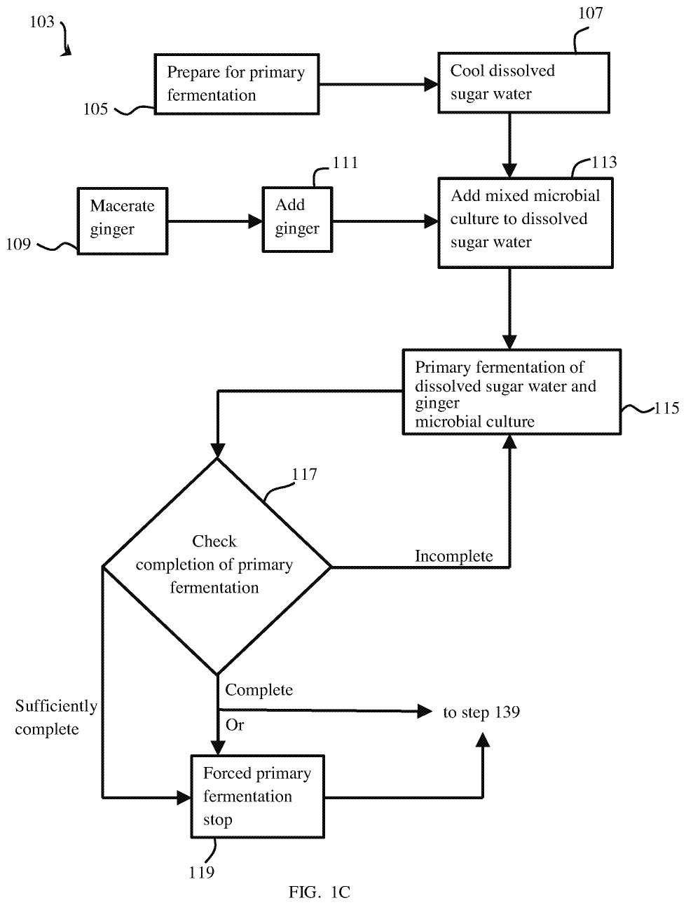

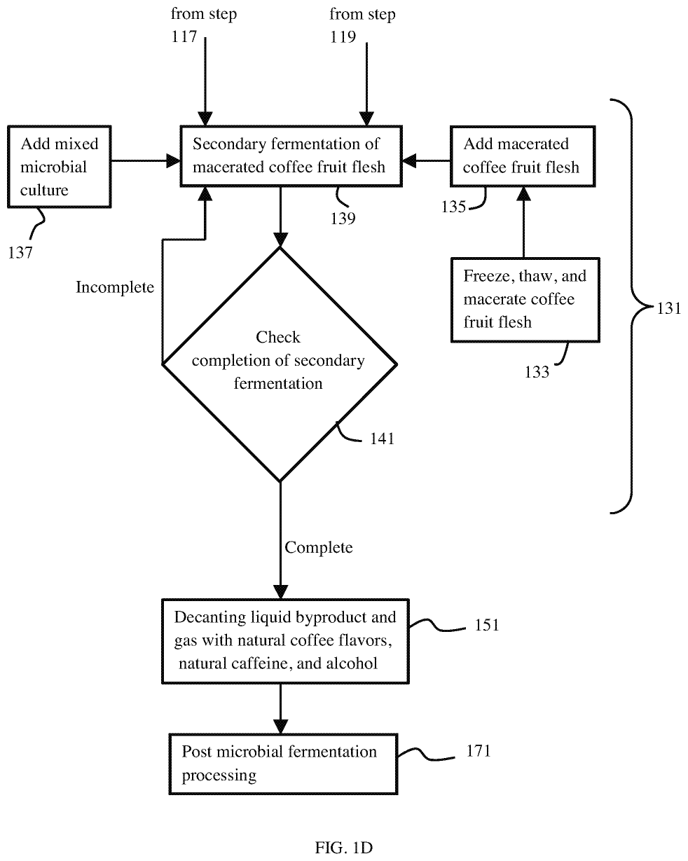

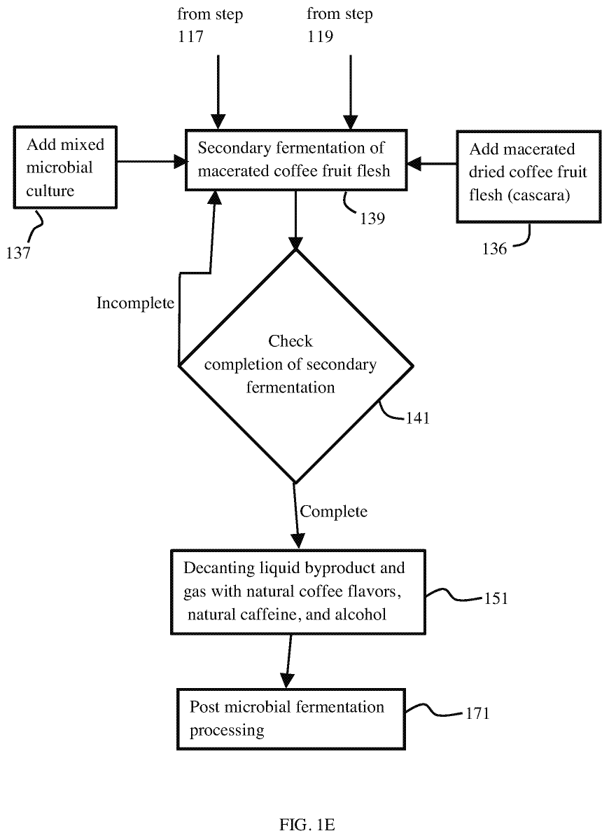

In some embodiments, the caffeinated coffee fruit alcoholic beverage may be manufactured by a method 100 comprising steps (processes). This method 100 may be a method for producing a caffeinated coffee fruit alcoholic beverage. This method 100 may be a method for producing a caffeinated coffee fruit alcoholic beverage; wherein at least some of the caffeine is naturally produced, at least some of the coffee fruit flavor is naturally produced, and at least some of the alcohol is naturally produced. This method 100 may comprise the steps of: microbially fermenting a mixture comprising coffee fruit flesh and water using a mixed microbial culture to naturally produce a liquid byproduct, as in step 101; decanting at least some portion from the liquid byproduct (and away from the lees, sediments, and/or expended pulp) to produce a decanted liquid, as in step 151; and the like. See e.g., FIG. 1A. In some embodiments, step 101 may comprise additional sub-steps, see e.g., FIG. 1B. In some embodiments, step 151 may comprise additional sub-steps. And in some embodiments, steps may precede step 101. And in some embodiments, additional steps may be used post step 151, e.g., post fermentation processing step(s) 171, such as but not limited to settling, inclusion of one or more secondary ingredients, filtration, and/or bottling.

In some embodiments, step 101 of microbial fermentation may comprise a two stage fermentation process as shown in FIG. 1B. In some embodiments, the two stage fermentation process may comprise a primary fermentation 103 and a secondary fermentation 131. In some embodiments, step 101 may comprise steps 103 and steps 131. See e.g., FIG. 1B.

In some embodiments, primary fermentation 103 may comprise a sugar based fermentation of dissolved sugar to produce a primary fermentation product. In some embodiments, the primary fermentation product may comprise at least some of the alcohol and a dominant established microbial culture. The dominant established microbial culture may be derived from the mixed microbial culture.

Note, in some embodiments, primary fermentation 103 may not comprise the mixture that may comprise the coffee fruit flesh. Rather in some embodiments, that mixture comprising the coffee fruit flesh may be added during secondary fermentation 131.

In some embodiments, the mixed microbial culture during primary fermentation 103 may comprise yeast and bacteria. In some embodiments, the mixed microbial culture during primary fermentation 103 may comprise a mixed SCOBY (a symbiotic colony of bacteria and yeast). In some embodiments, the mixed microbial culture during primary fermentation 103 may comprise substantially yeast. In some embodiments, the mixed microbial culture may be provided by a vendor White Labs and/or the like.

In some embodiments, the mixed microbial culture during primary fermentation 103 may be ginger beer plant (GBP), a SCOBY, comprised of yeast and bacteria. In some embodiments, GBP may comprise yeast Saccharomyces florentinus (formerly S. pyriformis), and bacterium Lactobacillus hilgardii (formerly Brevibacterium vermiforme). GBP may form a symbiotic colony of bacteria and yeast. GBP may form a gelatinous culture that may allow the culture to be readily transferred from one fermenting substrate to the next, much like kefir grains, kombucha, and tibicos.

In some embodiments, the mixed microbial culture during primary fermentation 103 may comprise Saccharomyces florentinus and Lactobacillus hilgardii. Saccharomyces florentinus may be a yeast which may substantially produce at least some of the alcohol from the sugar. Lactobacillus hilgardii may be a bacterium which converts at least some of the at least some alcohol into lactic acid and other organic acids, which may contribute to complexity of resulting flavor. In some embodiments, at least some of these other organic acids are natural coffee fruit flavors and contribute to the presence of the natural coffee fruit flavor in the caffeinated coffee fruit alcoholic beverage.

In some embodiments, initial pitching (adding) of the mixed microbial culture during primary fermentation 103 may comprise cell counts (of yeast) of 50 to 100 billion cells per gallon. In some embodiments, pitching may be step 113 in FIG. 1C. In some embodiments, the sugar may be added to the water to form the dissolved sugar, such that after primary fermentation 103, the produced alcohol may be present at about 1% ABV to 11% ABV. In some embodiments, the dissolved sugar in primary fermentation 103, may be present in a ratio of about 1 to 1 by weight (pounds) to volume (gallons), with respect to the water, to produce about 5% ABV. For example, and without limiting the scope of the present invention, about 1 pound of cane sugar may be dissolved in about 1 gallon of water to provide a food source for the mixed microbial culture to produce about 5% ABV by fermentation of the cane sugar. In some embodiments, 1% ABV may require about 0.2 pounds of sugar per gallon of water. In some embodiments, 10% ABV may require about 1.6 pounds of sugar per gallon of water. In some embodiments, the dissolved sugar in primary fermentation 103, may be present in a range of about 0.2 pounds of sugar per gallon of water to about 1.7 pounds of sugar per gallon water. Where “about” in this paragraph may be plus or minus 0.05 pounds of sugar; and about plus or minus 0.1 gallon of water.

In some embodiments, secondary fermentation 131 may comprise adding the mixture (comprising the coffee fruit flesh) to the primary fermentation product and then further fermentation of the primary fermentation product along with the mixture to produce the (natural) coffee fruit flavor, the (natural) caffeine, and potentially some additional of the (natural) alcohol. In some embodiments, the addition of the mixture (comprising the coffee fruit flesh) to the primary fermentation product may allow the dominant established culture to re-start fermentation.

Without a significant sugar source, fermentation of only the coffee fruit flesh may be poor (e.g., as compared to fermentation with cane sugar or the like as source material), which may be at least one reason, why primary fermentation 103 may utilize the sugar source as discussed above, to start and develop the mixed microbial culture with vitality, that then may be the dominant established culture, prior to adding the coffee fruit flesh.

In some embodiments that may utilize at least one other botanical element to impart additional natural flavor and/or natural color, the at least one other botanical element may be added to the mixture (comprising the coffee fruit flesh), which then may be added to the primary fermentation product and then further fermentation of the primary fermentation product along with the mixture may produce the (natural) coffee fruit flavor, the (natural) caffeine, the (natural) alcohol, additional natural flavor, and/or natural color.

In some embodiments, the mixed microbial culture during secondary fermentation 131 may comprise bacteria and yeast. At least one role of the bacteria may be to substantially produce the natural coffee fruit flavor from fermentation of the coffee fruit flesh. In some embodiments, the mixed microbial culture during secondary fermentation 131 may be substantially the dominant established culture. In some embodiments, from the initial pitching of the mixed microbial culture during primary fermentation 103, the dominant established culture during secondary fermentation 131 may comprise cell counts that may have doubled or more from the initial pitching of step 113 (see FIG. 1C for step 113).

In some embodiments, secondary fermentation 131 may comprise a step of adding additional microbes (e.g., bacteria and/or yeast) to the primary fermentation product and to the mixture, see e.g., step 137 in FIG. 1D. At least one role of such additional bacteria may be to substantially produce the natural coffee fruit flavor from fermentation of the coffee fruit flesh. In some embodiments, secondary fermentation 131 may comprise a step of adding different microbes (e.g., bacteria and/or yeast) to the primary fermentation product and to the mixture, see e.g., step 137 in FIG. 1D; wherein “different” is as compared against the mixed microbial culture added in step 113. At least one role of such different bacteria may be to substantially produce the natural coffee fruit flavor from fermentation of the coffee fruit flesh.

Note, in some embodiments, step 137 may be optional. That is, some implementations of secondary fermentation 131 may not utilize step 137. For example, in some embodiments, during check 117 the health of the mixed microbial culture may be assayed; and if determined to be weak (e.g., below a predetermined cell count), then inclusion of step 137 may be utilized as shown in FIG. 1D. Whereas, if the mixed microbial culture is above the predetermined cell count, then that mixed microbial culture may be deemed the dominant established microbial culture. In some embodiments the predetermined cell count is the initial cell count at pitching in step 113. In some embodiments, the predetermined cell count is about 1.5 or 2.0 times the initial cell count at pitching in step 113. When the mixed microbial culture may be deemed the dominant established microbial culture, then step 137 may not be carried out in some embodiments.

In some embodiments, secondary fermentation 131 may extract caffeine from the coffee fruit flesh and into the liquid byproduct. In some embodiments, when microbial fermentation 101 (e.g., secondary fermentation 131) may use coffee fruit flesh with no coffee beans as at least one of the source materials, post fermentation, the liquid byproduct may comprise caffeine at about 1 milligram (mg) per 100 gram (g) of the liquid byproduct, to about 20 mg per 100 g of the liquid byproduct, per HPLC assay methods, such as AOAC 979.08. In comparison, such caffeine concentrations in the caffeinated coffee fruit alcoholic beverage may be less than the amount of caffeine typically found in a comparable amount of coffee the common beverage, tea the beverage, or dark chocolate. In comparison, such caffeine concentrations in the caffeinated coffee fruit alcoholic beverage may be about the same or less than the amount of caffeine typically found in a comparable amount of cola type soda beverage.

Also as expected, inclusion of the coffee bean along with the coffee fruit in microbial fermentation 101 (e.g., secondary fermentation 131) does result in greater caffeine concentrations in the resulting beverage as compared to if no coffee beans were utilized. Including the coffee beans greatly increases costs as compared to just utilizing the coffee fruit without the coffee beans; and aside from an increase in caffeine concentration, inclusion of the coffee beans tends to inhibit fermentation, as the coffee beans have very little sugar content as a source for the microbial fermentation. And in some embodiments, it may be desirable to have less caffeine than what may be contributed by including coffee beans during fermentation. Inclusion of coffee beans as source material for fermentation may also result in an end product with excessive and undesirable bitterness. Unexpectedly, inclusion of coffee beans as source material for fermentation may result in undesirable odor of the end product. Some exemplary methods may not utilize coffee beans for at least these reasons.

However, an unexpected result was obtained with respect to caffeine concentrations derived from microbial fermentation 101 (e.g., secondary fermentation 131) of the coffee fruit (without the coffee beans). It was anticipated that microbial fermentation of the previously frozen, thawed, and macerated coffee fruit would produce a marked increase of final caffeine concentration in the resulting liquid byproduct, because of microbial cell interactions with the coffee fruit cells would cause more caffeine to be released and extracted from the coffee fruit cells. That is, it was thought that microbial fermentation would assist in the caffeine extraction process of releasing caffeine from the coffee fruit flesh, that would result in a marked caffeine concentration increase in the resulting liquid byproduct. However, pre and post fermentation tests for caffeine concentration showed about the same levels of caffeine. And as it turns out, this unexpected result is beneficial for such an alcoholic beverage, because while a goal was to create a naturally caffeinated and naturally alcoholic beverage, too much caffeine concentration may be undesirable; i.e., if the fermentation had produced the expected marked increase in caffeine concentration, that resulting liquid byproduct may have needed further processing to remove excess caffeine. This unexpected result may in part be due to fermentation producing ethanol where caffeine is less soluble in as compared to water. It may be important to balance the amount of caffeine with respect to the amount of alcohol in the resulting beverage, because caffeine is a stimulant and alcohol is a depressant, such that with the proper balance, a desirable caffeinated alcoholic beverage results. This proper balance may be a caffeine concentration of about 1 mg per 100 g of beverage to about 20 mg per 100 g of beverage; and with the alcohol content being about 1% to about 11% ABV in the beverage.

In some embodiments, the coffee fruit flesh in the mixture may be present in a ratio of about one pound to about three pounds of coffee fruit flesh to one gallon of the primary fermentation product.

In some embodiments, the secondary fermentation 131 may further comprise adding ginger (e.g., ginger root) to be fermented with the mixture and the further fermentation of the primary fermentation product to produce the natural ginger root flavor, the natural coffee fruit flavor, the natural caffeine, and the natural alcohol in the liquid byproduct. In some exemplary embodiments, ginger (e.g., ginger root) may be added to the dissolved sugar of the primary fermentation 103 and during or prior to the primary fermentation 103; such as in step 111 (see FIG. 1C). In some embodiments, where the mixed microbial culture may comprise the GBP SCOBY, then ginger (e.g., ginger root) may be added to the dissolved sugar of primary fermentation 103 and during or prior to primary fermentation 103. See e.g., step 111 in FIG. 1C. Adding ginger during or prior to primary fermentation 103 when the mixed microbial culture may comprise the GBP SCOBY may increase growth and/or vitality of the mixed microbial culture, aiding in producing the dominant established microbial culture from the mixed microbial culture.

In some embodiments, ginger root may be present in a ratio of about 0.25 pound to about 1.00 pound of ginger root per gallon of water or per gallon of the primary fermentation product. In some embodiments, ginger root may be present in a ratio of about 0.25 pounds to about 0.50 pounds per gallon of water or of the primary fermentation product. In some embodiments, ginger root may be present in a ratio of less than 1.0 pound per gallon of water or of the primary fermentation product. In some embodiments, prior to step 111 of adding the ginger, step 111 may be preceded by step 109 of macerating the ginger. Where “about” in this paragraph may be plus or minus 0.05 pound of ginger root and plus or minus 0.1 gallon. See e.g., FIG. 1C.

In some embodiments, primary fermentation 103 may come substantially to completion (which in some embodiments may include a forced fermentation stop, as in step 119, e.g., by chilling) prior to initiating secondary fermentation 131. See e.g., FIG. 1C.

In some embodiments, primary fermentation 103 and secondary fermentation 131 may overlap with primary fermentation 103 starting before starting secondary fermentation 131. In some embodiments, primary fermentation 103 and secondary fermentation 131 may occur concurrently.

In some embodiments, prior to a step of secondary fermentation of the coffee fruit flesh, as in step 139 (see FIG. 1D), the method may comprise a step of macerating the coffee fruit flesh, as in step 133, to assist in providing the mixed microbial culture (or the dominant established microbial culture) access (e.g., via increased surface area and/or cell wall ruptures) to cellular contents and cellular structures (e.g., cell wall components) of the coffee fruit flesh during microbial fermentation 101, e.g., during the steps of the secondary fermentation 131. See e.g., FIG. 1D.

In some embodiments, prior to the step of secondary fermentation of the coffee fruit flesh, as in step 139 (see FIG. 1D), the method may comprises a step of freezing the coffee fruit flesh, as in step 133, to assist in breaking down cells and cell walls of the coffee fruit flesh, which may assist in providing the mixed microbial culture (and/or the dominant established microbial culture) access to cellular contents and cellular structures (e.g., cell wall components) of the coffee fruit flesh assisting with the microbial fermentation 101, e.g., in the steps of secondary fermentation 131. See e.g., FIG. 1D.

In some embodiments, prior to the step of secondary fermentation of the coffee fruit flesh, as in step 139 (see FIG. 1D), the method may comprise a step of macerating and freezing the coffee fruit flesh, as in step 133, to assist in breaking down cells and cell walls of the coffee fruit flesh, which may assist in providing the mixed microbial culture (and/or the dominant established microbial culture) access to cellular contents and cellular structures (e.g., cell wall components) of the coffee fruit flesh assisting with the microbial fermentation 101, e.g., in the steps of secondary fermentation 131. See e.g., FIG. 1D.

In some embodiments, prior to adding the coffee fruit flesh to a fermentation vessel, as in step 135, the method may comprise steps of macerating, freezing and thawing, and/or of macerating with freezing and thawing of the coffee fruit flesh, as in step 133, to assist in breaking down cells and cell walls of the coffee fruit flesh, which may assist in providing the mixed microbial culture (and/or the dominant established microbial culture) access to cellular contents and cellular structures (e.g., cell wall components) of the coffee fruit flesh assisting microbial fermentation 101, e.g., in the steps of secondary fermentation 131. See e.g., FIG. 1D.

In some embodiments, maceration and/or freezing and thawing of the coffee fruit flesh, as in step 133, may also aid in increasing the natural caffeine content in the beverage. In some embodiments, maceration and/or freezing and thawing of the coffee fruit flesh, as in step 133, may also aid in increasing the natural coffee fruit flavor content in the beverage.

In some embodiments, prior to adding the ginger to the fermentation vessel, e.g., in step 111, the method may comprise steps of macerating, freezing and thawing, and/or of macerating with freezing and thawing of the ginger, e.g., as in step 109, to assist in breaking down cells and cell walls of the ginger, which may assist in providing the mixed microbial culture (and/or the dominant established microbial culture) access to cellular contents and cellular structures (e.g., cell wall components) of the ginger assisting with the microbial fermentation steps, such as step 101, step 103, step 115, step 131, and/or step 139.

In some embodiments, maceration and/or freezing and thawing of the ginger, e.g., as in step 109, may also aid in increasing the natural ginger flavor in the beverage. See e.g., FIG. 1C.

In some embodiments, prior to adding the botanical element to the fermentation vessel, the method may comprise steps of macerating, freezing and thawing, and/or of macerating with freezing and thawing of the botanical element to assist in breaking down cells and cell walls of the botanical element, which may assist in providing the mixed microbial culture (and/or the dominant established microbial culture) access to cellular contents and cellular structures (e.g., cell wall components) of the botanical element assisting with the microbial fermentation steps; such as step 101, step 103, step 115, step 131, and/or step 139.

In some embodiments, the step of microbial fermentation 101 may produce at least some carbonation within the liquid byproduct. Microbial fermentation 101 may produce carbon dioxide (CO2) gas as a natural byproduct of the microbial fermentation metabolic pathway. In some embodiments, steps of primary fermentation 103 and/or of secondary fermentation 131 may produce at least some of the carbon dioxide (CO2) carbonation within the caffeinated coffee fruit alcoholic beverage.

In some embodiments, the method may further comprise subjecting the decanted liquid of step 151 to forced carbonation. In some embodiments, forced carbonation may occur post fermentation, such as in step 171. See e.g., FIG. 1A and FIG. 1D. For example, and without limiting the scope of the present invention, forced carbonation may occur by pumping dissolved gas (e.g., CO2 and/or N2) into a sealed vessel containing the decanted liquid, i.e., into the caffeinated coffee fruit alcoholic beverage. Some embodiments may utilize natural carbonation from microbial fermentation 101 followed by forced carbonation in step 171. In some embodiments, forced carbonation may occur as an alternative to natural carbonation from microbial fermentation 101. In some embodiments, irrespective of carbonation method (e.g., via microbial fermentation 101 or forced, or via both microbial fermentation and forced), the dissolved gas may be present in a quantity of the decanted liquid or in the final beverage in a range of about 1.25 to 3.30 volumes of the dissolved gas (e.g., CO2 or N2).

In some embodiments, the method may further comprise adding at least one secondary ingredient to the decanted liquid, e.g., during step 171. See e.g., FIG. 1A and FIG. 1D. The secondary ingredient may be selected from one or more of the group comprising: a flavor, dissolved gas, a sweetener, a preservative, a stabilizer, a colorant, and a pH adjusting species, and the like. In some embodiments, addition of the at least one secondary ingredient may occur post fermentation.

In some embodiments, post fermentation, the method may comprise various post fermentation processing steps, as in step 171. In some embodiments, post fermentation, the method may comprise a settling step of the decanted liquid, allowing suspended particulates to settle at a bottom of a holding vessel. In some embodiments, post fermentation, the method may comprise a filtration step of the decanted liquid. See step 171 in FIGS. 1A and 1n FIG. 1D.

In some embodiments, the method may further comprise bottling the decanted liquid into at least one beverage container, which may a post microbial fermentation processing step 171. The at least one beverage container may be sized for consumer use. In some embodiments, consumer sizes may range from about 50 mL to about 20 gallons (e.g., as in keg type vessels). In some embodiments, consumer sizes may range from about 50 mL to about 3 L. For example, and without limiting the scope of the present invention, individual glass bottles for the at least one beverage container may be sized at 50 mL, 330 mL, 500 mL, 750 mL, 1.75 L, 2 L, 3 L, and/or the like. In some embodiments, consumer sizes may range from about 8 ounces (oz.) to about 22 oz. For example and without limiting the scope of the present invention, individual glass bottles and/or aluminum cans may be sized at 8 oz., 9.30 oz., 11.2 oz., 12 oz., 14.9 oz., 16.9 oz., 20 oz., 22 oz., and/or the like.

In some embodiments, the at least one beverage container may be substantially glass, e.g., a glass bottle. In some embodiments, the at least one beverage container may be substantially a thermoformed plastic, e.g., a plastic bottle. In some embodiments, the at least one beverage container may be glass lined. In some embodiments, the at least one beverage container may be plastic lined. In some embodiments, the at least one beverage container may be substantially aluminum, e.g., an aluminum can. In some embodiments, the at least one beverage container may be a sealed vessel. In some embodiments, the at least one beverage container may be a sealed vessel that may be pressurized (e.g., by dissolved gas); and/or sealed with contents under pressure.

In some exemplary embodiments, method 100 for producing a caffeinated coffee fruit alcoholic beverage may comprise the following steps: step 101, step 151, and step 171. See e.g., FIG. 1A. In some embodiments, step 101 may be the step of microbially fermenting a mixture of macerated coffee fruit flesh, sugar, and water, using the mixed microbial culture and/or using the dominant established microbial culture. In some embodiments, step 151 may comprise decanting the liquid byproduct from the microbial fermentation, with at least some of the natural coffee fruit flavors, at least some of the natural caffeine, and at least some of the natural alcohol from the result of the microbial fermentation 101. In some embodiments, such a decanting step, may also involve capturing at least some of the carbon dioxide, some of which is dissolved, produced from microbial fermentation 101. In some embodiments, step 171 may comprise further post microbial fermentation processing steps, such as, but not limited to, one or more of the following: settling, filtering, adding secondary ingredient(s), adding flavors, adding sweeteners, adding preservatives, adding stabilizers, adding colorants, adding pH adjusting species, adding the gas, adding the dissolved gas, and/or bottling.

As noted above, as shown in FIG. 1B, in some embodiments, microbial fermentation 101 may comprise a two stage fermentation process, i.e., that of primary fermentation 103 and that of secondary fermentation 131. FIG. 1C may then show various steps that may comprise primary fermentation 103. While FIG. 1D may then show various steps that may comprise secondary fermentation 131, along with the decanting step 151, and the post microbial fermentation processing step 171.

Turning back to FIG. 1C, in some embodiments, primary fermentation 103 may comprise the following steps: step 105, step 107, step 113, step 115, and step 117. Step 105 may be a step of preparing for the primary fermentation. Step 107 may be a step of cooling dissolved sugar water down to an appropriate temperature for microbial fermentation. Step 113 may be a step of adding the mixed microbial culture to the dissolved sugar water. Step 115 may be the actual step of primary fermentation of the dissolved sugar water using the mixed microbial culture. And step 117 may be a step of checking to see if the primary fermentation has completed. See e.g., FIG. 1C.

Pre-fermentation steps: In some embodiments, the botanical element ingredients, such as the coffee fruit flesh (e.g., without coffee beans) and the ginger (e.g., ginger root) may be macerated, frozen, and thawed, prior to use as a source material for fermentation. During such maceration, freezing, and thawing, the coffee fruit flesh, the ginger, and/or other botanical element ingredients may be kept separately in some embodiments or mixed together in other embodiments. For example, and without limiting the scope of the present invention, in some embodiments, step 109 as shown in FIG. 1C, may be a step of at least macerating ginger, prior to step 111 of adding that now macerated ginger to a vessel (e.g., a fermentation vessel) along with the dissolved sugar water and the mixed microbial culture. See e.g., FIG. 1C.

Step 105: In some embodiments, microbial fermentation 101 may proceed first with preparing for primary fermentation 103, as in step 105, wherein sugar may be dissolved in water, within a vessel (e.g., a kettle). In some embodiments, water may be heated to about 160 degrees Fahrenheit (where about here in this sentence may be plus or minus 5 degrees). In some embodiments, the dissolved sugar in primary fermentation 103, may be present in a ratio of about 1 to 1 by weight (pounds) to volume (gallons), with respect to the water, to produce about 5% ABV. For example, and without limiting the scope of the present invention, about 1 pound of cane sugar may be dissolved in about 1 gallon of water to provide a food source for the mixed microbial culture to produce about 5% ABV by fermentation of the cane sugar. In some embodiments, 1% ABV may require about 0.2 pounds of sugar per gallon of water. In some embodiments, 10% ABV may require about 1.6 pounds of sugar per gallon of water. In some embodiments, the dissolved sugar in primary fermentation 103, may be present in a range of about 0.2 pounds of sugar per gallon of water to about 1.7 pounds of sugar per gallon water. Where “about” in this paragraph may be plus or minus 0.05 pounds of sugar; and about plus or minus 0.1 gallon of water. See e.g., FIG. 1C.

Step 107: Next in some embodiments, the dissolved sugar water may be then cooled to about 70 degrees Fahrenheit (where about in this sentence is plus or minus five degrees) or any other temperature generally suitable for conducting microbial fermentation with the mixed microbial culture. This may be forced cooling for example, with the aid of a heat exchanger. See e.g., FIG. 1C.

Next in some embodiments, the cooled dissolved sugar water may then be transferred to a fermentation vessel, if for example, the initial vessel (kettle) was not a fermentation vessel. In some embodiments, the fermentation vessel may be sanitary. In some embodiments, the fermentation vessel may have been previously sterilized. In some embodiments, the fermentation vessel may comprise at least one excessive pressure bleed valve, i.e., a gas check valve; one or more sampling sealable sampling ports; and/or one or more decanting sealable ports.

Step 113: Next in some embodiments, to the cooled dissolved sugar water, the mixed microbial culture may be added. In some embodiments, the mixed microbial culture may be the GBP SCOBY. In some embodiments, initial pitching of the mixed microbial culture during the primary fermentation may comprise cell counts (of yeast) of 50 to 100 billion cells per gallon. See e.g., FIG. 1C.

Step 111: In some embodiments, where the mixed microbial culture may comprise the GBP SCOBY, ginger (e.g., ginger root) may be added to the cooled dissolved sugar water within the fermentation vessel. The ginger in some embodiments, may have been previously macerated and/or macerated, frozen, and thawed, e.g., as in step 109. Adding ginger during or prior to the actual primary fermentation step 115, when the mixed microbial culture may comprise the GBP SCOBY may increase growth and/or vitality of the mixed microbial culture, aiding in producing the dominant established microbial culture from the mixed microbial culture. In some embodiments, ginger root may be present in a ratio of about 0.25 pound to about 1.00 pound of ginger root per gallon of the dissolved sugar water. Where “about” in this paragraph may be plus or minus 0.05 pound of ginger root and plus or minus 0.1 gallon. See e.g., FIG. 1C.

Next in some embodiments, in preparation for step 115, the fermentation vessel may be sealed and pressurized with air (which may be filtered) and/or pressurized with oxygen. In some embodiments, the fermentation vessel may comprise a porous oxygenation stone or aeration stone.

Step 115: Next in some embodiments, primary fermentation may then proceed at about 65 to about 68 degrees Fahrenheit (where about is plus or minus three degrees) or any other temperature generally suitable for conducting microbial fermentation with the mixed microbial culture. Primary fermentation 115 may proceed until substantially all of the sugar present in the dissolved sugar water may be consumed by the mixed microbial culture. At this point, the fermentation vessel may also then comprise natural alcohol, at about 1% to 11% ABV, depending upon how much sugar may have been initially dissolved and then subsequently consumed by the microbes using the sugar as a fuel source for the fermentation. Additionally, at this point, the fermentation vessel may comprise natural ginger flavor, e.g., if step 111 was carried out. See e.g., FIG. 1C. In total, an end product from step 115 may be the primary fermentation product; wherein the liquid phase is the most desired; or wherein the liquid phase and the gas phase are the more desired.

Step 117: In some embodiments, completion of primary fermentation 115 may be checked by a measurement of final gravity (terminal gravity), which may correlate to sweetness/dryness. See e.g., FIG. 1C. Measurements of final gravity (terminal gravity) may indicate when fermentation may be complete, sufficiently complete (near complete), or incomplete. Measurements of final gravity (terminal gravity) may indicate sugar density within the liquid phase of the fermentation vessel. For example, and without limiting the scope of the present invention, final gravity (terminal gravity) measurements of at about 1.012 may indicate a sweet beverage. For example, and without limiting the scope of the present invention, final gravity (terminal gravity) measurements of above 1.024 may indicate cloying (unpleasantly sweet). For example, and without limiting the scope of the present invention, final gravity (terminal gravity) measurements of below 1.012 may indicate a dry beverage. For example, and without limiting the scope of the present invention, final gravity (terminal gravity) measurements of below 1.000 may indicate an ultra-dry and sour beverage.

In some embodiments, complete fermentation or sufficiently complete fermentation may comprise a final gravity (terminal gravity) range of about 1.000 to 1.012; wherein “about” here may indicate plus or minus 0.001.

In some embodiments, in step 117 of checking for completion of the primary fermentation, that check may have at least one of three outcomes: (a) determining that the primary fermentation was incomplete; (b) determining that the primary fermentation was complete; or (c) determining that the primary fermentation was sufficiently complete. If check 117 determines that the primary fermentation is incomplete, further fermentation may proceed as in step 115. If check 117 determines that the primary fermentation is complete, then step 117 may proceed into step 139, wherein step 139 may be depicted in FIG. 1D. If check 117 determines that the primary fermentation is sufficiently complete, step 117 may proceed to step 119; wherein step 119 may be a forced primary fermentation stop step, e.g., by chilling of the fermentation vessel or chilling of the contents of the fermentation vessel. See e.g., FIG. 1C. In some embodiments, check 117 determining that the primary fermentation is complete may also progress to step 119 before progressing to step 139. Initiating a forced fermentation stop as in step 119 prior to step 139, even when primary fermentation may be complete per check 117, may provide for uniformity and/or quality control as between batches.

In some embodiments, in step 117, during that check, the health of the mixed microbial culture may be assayed; and if determined to be weak (e.g., below a predetermined cell count), then inclusion of step 137 may be utilized shown in FIG. 1D. Whereas, if the mixed microbial culture is above the predetermined cell count, then that mixed microbial culture may be deemed the dominant established microbial culture. In some embodiments the predetermined cell count is the initial cell count at pitching in step 113. In some embodiments, the predetermined cell count is about 1.5 or 2.0 times the initial cell count at pitching in step 113. When the mixed microbial culture may be deemed the dominant established microbial culture, then step 137 may not be carried out in some embodiments. (Step 137 may be depicted in FIG. 1D.)

Now turning to discussing FIG. 1D. In some embodiments, secondary fermentation 131 may comprise steps: step 135 and step 139. In some embodiments, secondary fermentation 131 may comprise steps: step 133, step 135, and step 139. In some embodiments, secondary fermentation 131 may comprise steps: step 135, step 139, and step 141. In some embodiments, secondary fermentation 131 may comprise steps: step 133, step 135, step 139, and step 141. In some embodiments, at noted above, step 137 may feed into step 139. See e.g., FIG. 1D.

Step 135: Next in some embodiments, the coffee fruit flesh (e.g., without coffee beans) may be added to the fermentation vessel and the fermentation vessel re-sealed. Secondary fermentation 139 may then proceed at about 65 to about 68 degrees Fahrenheit (where about may be plus or minus three degrees) or any other temperature generally suitable for conducting microbial fermentation with the mixed microbial culture or with the dominant established microbial culture. Addition of this coffee fruit flesh may re-start fermentation, starting secondary fermentation 139, wherein at least some of the natural coffee fruit flavor may be produced. Prior to adding this coffee fruit flesh to the fermentation vessel, the coffee fruit flesh may have been macerated and/or macerated, frozen, and thawed, as in step 133. In some embodiments, the coffee fruit flesh added to the fermentation vessel may be present in a ratio of about one pound to about three pounds of coffee fruit flesh to one gallon of the primary fermentation product. Where “about” in this paragraph may be plus or minus 0.1 pound of coffee fruit flesh and plus or minus 0.1 gallon.

Additionally, addition of the coffee fruit flesh (e.g., via step 135) provides the natural source for at least some of the natural caffeine, wherein the natural caffeine is released and extracted from the macerated, frozen, thawed, and fermenting coffee fruit flesh.

Additionally, microbial fermentation 101, primary fermentation 103, and/or secondary fermentation 131 may produce carbon dioxide gas, which may be present as a dissolved gas and in the headspace of the fermentation vessel. The pressure bleed valve may be set such that the carbon dioxide may be present in the fermentation vessel at about 1.25 to 3.30 volumes of carbon dioxide.

Step 141: In some embodiments, completion of secondary fermentation 139 may be checked by a measurement of final gravity (terminal gravity), which may correlate to sweetness/dryness. See e.g., FIG. 1D. Measurements of final gravity (terminal gravity) may indicate when secondary fermentation 139 may be complete or incomplete.

In some embodiments, complete secondary fermentation 139 may comprise a final gravity (terminal gravity) range of about 1.000 to 1.012 of the liquid phase in the fermentation vessel; wherein “about” here may indicate plus or minus 0.001.

If check 141 determines that secondary fermentation 139 is incomplete, further fermentation may proceed as in step 139. If check 141 determines that secondary fermentation 139 is complete, then step 141 may proceed into step 151. In some embodiments, check 141 determining that secondary fermentation 139 is complete may also progress to a forced fermentation stop step (e.g., similar to step 119) before progressing to step 151.

Step 151: Next in some embodiments, upon completion of secondary fermentation 139, e.g., as determined in check 141, at least some portion of the liquid byproduct may be decanted from the lees, sediments, and/or expended coffee fruit pulp in the fermentation vessel to produce the decanted liquid.

In some embodiments, post fermentation, the decanted liquid may be subjected to various post fermentation processes 171, such as, but not limited, settling, filtration, treatment with various secondary ingredients, and/or bottling. See e.g., FIG. 1D.

The primary fermentation 115 and/or the secondary fermentation 139 may be halted or slowed by chilling, e.g., to artificially impose an equivalent state of fermentation completion. See e.g., step 119 in FIG. 1C.

Now turning to discussing FIG. 1E. In some embodiments, the steps shown in FIG. 1E may be alternative steps to those steps shown in FIG. 1D. In some embodiments, in FIG. 1E, step 136 may replace steps 133, and/or 135. In some embodiments, secondary fermentation 131 may utilize step 136. In some embodiments, the fermentation (primary and/or secondary) may utilize step 136. In some embodiments, step 136 may be a step of adding dried coffee fruit husks (flesh) (“husks” herein may mean that the coffee fruit flesh had been previously dried). In some embodiments, step 136 may be a step of the method receiving the dried coffee fruit husks. In some embodiments, the dried coffee fruit husks may be known as cascara. In some embodiments, the dried coffee fruit husks may be without beans. In some embodiments, the dried coffee fruit husks may be with beans. In some embodiments, the dried coffee fruit husks may be dehydrated and/or substantially (mostly) dehydrated. In some embodiments, the dried coffee fruit husks may be with or without preservatives. In some embodiments, the drying and/or dehydration process used to generate the dried coffee fruit husks may not involve roasting of the coffee fruit. In some embodiments, the drying and/or dehydration process used to generate the dried coffee fruit husks may involve air and/or sun (solar) drying of the coffee fruit. In some embodiments, fresh coffee fruit flesh may be dried to generate the dried coffee fruit husks; however, the generated dried coffee fruit husks may not be fresh. In some embodiments, the dried coffee fruit husks may have superior shelf life versus non-dried, but picked/harvested, coffee fruit flesh. In some embodiments, the dried coffee fruit husks may have advantages over frozen coffee fruit flesh because with the dried coffee fruit husks there is no need for freezing and/or refrigeration, which may allow for less costly shipping and/or storage of the dried coffee fruit husks versus frozen coffee fruit flesh.

In some embodiments, step 136 (in FIG. 1E) may include steeping the dried coffee fruit husks in water. In some embodiments, such steeping may be done at about 150 degrees Fahrenheit, plus or minus 5 degrees Fahrenheit, for about 20 minutes, plus or minus 5 minutes.

In some embodiments, the method for producing the caffeinated coffee fruit alcoholic beverage, prior to step 131 of the secondary fermentation, the method may comprise step 136 of macerating, steeping, or macerating and steeping the coffee fruit husks, that were previously dried, to assist in breaking down cells and cell walls of the coffee fruit husks providing the dominant established microbial culture access to cellular contents and cellular structures of the coffee fruit husks during step 131 of the secondary fermentation.

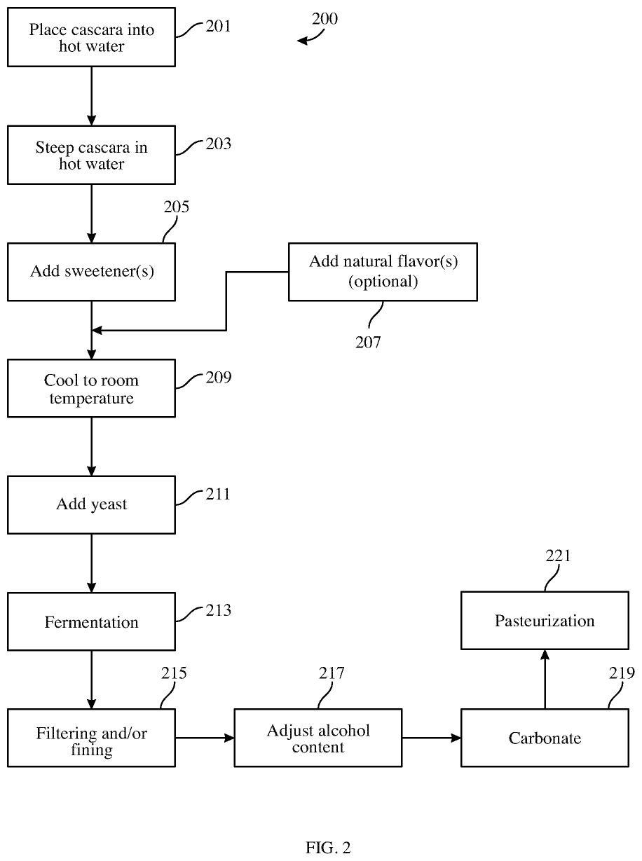

FIG. 2 may show at least some steps in a method 200. FIG. 2 may be a flow diagram of at least some steps in method 200. In some embodiments, method 200 may be a method of producing a caffeinated alcoholic coffee fruit beverage. In some embodiments, method 200 may be a method of producing a naturally caffeinated alcoholic coffee fruit beverage. In some embodiments, method 200 may be a method of producing an alcoholic beverage from fermenting of coffee fruit, with caffeine that is naturally occurring in the coffee fruit. In some embodiments, method 200 may comprise at least eight of the following steps: step 201, step 203, step 205, step 207, step 209, step 211, step 213, step 215, step 217, step 219, step 221, combinations thereof, and/or the like.

Continuing discussing FIG. 2, in some embodiments, step 201 may be a step of placing predetermined amount of cascara into a predetermined amount of hot water, in a vessel. In some embodiments, about 150 grams (g) to about 500 g of cascara per one gallon (gal) of water may be used. For example, and without limiting the scope of the present invention, about 190 g of cascara may be used per one gallon of water. In some embodiments, this water may be purified water and/or filtered water. Wherein “about” in these contexts may be plus or minus 5 g of cascara. In some embodiments, the hot water may have a temperature from about 120 degrees Fahrenheit to about 212 degrees Fahrenheit, wherein “about” in this context may be plus or minus 5 degrees Fahrenheit. In some embodiments, step 201 may produce a first mixture. Note, “solution” may be interchanged for “mixture” herein. In some embodiments, step 201 may progress into step 203.

Continuing discussing FIG. 2, in some embodiments, step 203 may be a step of steeping the mixture resulting from step 201. In some embodiments, this steeping may occur at temperatures from about 130 degrees Fahrenheit to about 212 degrees Fahrenheit, wherein “about” in this context may be plus or minus 5 degrees Fahrenheit. In some embodiments, this steeping may go on from about 5 minutes to about 35 minutes, wherein “about” in this context may be plus or minus 1 minute. In some embodiments, step 203 may result in a cascara tea. In some embodiments, step 203 may produce a second mixture. In some embodiments, the second mixture may comprise natural caffeine from the dried coffee fruit (cascara). In some embodiments, step 203 may progress into step 205.

Continuing discussing FIG. 2, in some embodiments, step 205 may be a step of adding a predetermined amount of at least one sweetener to the result of step 203. In some embodiments, the at least one sweetener may be selected from the sweeteners discussed and noted above. In some embodiments, the at least one sweetener may be sugar and honey. In some embodiments, the sugar may be granulated white sugar. In some embodiments, the sugar may be dextrose (e.g., corn sugar). In other embodiments, other types of predetermined sweeteners may be used. In some embodiments, the honey may be orange blossom honey; in other embodiments, other predetermined types of honey may be used. In some embodiments, step 205 may produce a third mixture. In some embodiments, step 205 may progress into step 209.

Continuing discussing FIG. 2, in some embodiments, step 207 may be a step of adding a predetermined amount of at least one flavor to the result of step 203. In some embodiments, the at least one flavor may be selected from a flavor discussed and noted above. In some embodiments, the at least one flavor may be one or more natural flavors. In some embodiments, the at least one flavor may be one or more other teas. In some embodiments, the at least one flavor may be one or more other herbal teas. In some embodiments, the at least one flavor may be one or more other herbal teas, such as, but not limited to, hibiscus herbal tea, lemon herbal tea, combinations thereof, and/or the like. In some embodiments, step 207 may produce the third mixture. In some embodiments, step 207 may be optional in method 600. In some embodiments, method 600 may be without step 207. In some embodiments, step 207 may progress into step 209.

Continuing discussing FIG. 2, in some embodiments, step 209 may be a step of cooling the result of step 205 to room temperature. In some embodiments, step 209 may be a step of cooling the result of step 205 and step 207 to room temperature. In some embodiments, the result of step 205 or the result of step 205 and step 207 may be permitted to naturally cool down until reaching the surrounding room temperature. In some embodiments, room temperature may be from about 49 degrees Fahrenheit to about 80 degrees Fahrenheit, wherein “about” in this context may be plus or minus 4 degrees Fahrenheit. In some embodiments, this cooling step 209 may occur without active/forced cooling means (e.g., in some embodiments, a chiller, freezer, refrigerator, ice, combinations thereof, and/or the like may not be used in this cooling step 209). Whereas, in some other embodiments, this cooling step 209 may be accelerated by active/forced cooling means (e.g., in some embodiments, a chiller, freezer, refrigerator, ice, combinations thereof, and/or the like may be used in this cooling step 209). In some embodiments, step 209 may produce a fourth mixture. In some embodiments, step 209 may progress into step 211.

Continuing discussing FIG. 2, in some embodiments, step 211 may be a step of adding a predetermined amount of at least one predetermined type of microbe to the result of step 209 for a purpose of fermenting the result of step 209. In some embodiments, step 211 may be a step of inoculating the result of step 209 with the at least one predetermined type of microbe, in the predetermined amount, for fermentation purposes. In some embodiments, the hydrating and/or inoculating step of step 211 of the at least one predetermined type of microbe may be occurring in the same vessel as the product from step 209. In some embodiments, step 211 may not commence until the product of step 209 is 80 degrees Fahrenheit or less. Higher temperatures may harm and/or kill the at least one predetermined type of microbe. In some embodiments, an amount of the at least one predetermined type of microbe to the total volume may be about 1 gram (g) to about 5 g per gallon (gal). In some embodiments, in step 211 the at least one predetermined type of microbe may need to be hydrated (or rehydrated). In some embodiments, the predetermined type of microbe may be a yeast. In some embodiments, the yeast may be a champagne yeast. In other embodiments the yeast may be another type of predetermined yeast. In some embodiments, step 211 may produce a fifth mixture. In some embodiments, step 211 may progress into step 213.

Continuing discussing FIG. 2, in some embodiments, step 213 may be a step of fermenting the result of step 211. In some embodiments, this fermentation may occur in a completely sealed/closed vessel. In some embodiments, this fermentation may occur at about room temperature, wherein “about” in this context may be plus or minus 5 degrees Fahrenheit. In some embodiments, this fermentation may occur at about 60 degrees Fahrenheit to about 90 degrees Fahrenheit, wherein “about” in this context may be plus or minus 5 degrees Fahrenheit. In some embodiments, this fermentation may go on from about 5 days to about 60 days, wherein “about” in this context may be plus or minus 1 day. For example, and without limiting the scope of the present invention, this fermentation may go on for about ten days to about 14 days, wherein “about” in this context may be plus or minus 1 day. In some embodiments, step 213 may generate alcohol (e.g., ethanol) and/or may generate carbon dioxide (CO2). In some embodiments, there may be no other fermentation steps in method 600 other than step 213; i.e., there may no secondary fermentation occurring in method 600 and no tertiary fermentation occurring in method 600. In some embodiments, the fermentation step 213 may not be of a solution and/or mixture that included coffee beans. In some embodiments, step 213 may produce a sixth mixture. In some embodiments, this fermentation step 213 may produce further caffeine from the cascara. In some embodiments, this sixth mixture in addition to the ethanol and the carbon dioxide, may also comprise at least some of the caffeine from the steeped and now fermented cascara. In some embodiments, step 213 may progress into step 215.

Continuing discussing FIG. 2, in some embodiments, step 215 may be a step of filtering and/or fining the result of step 213. In some embodiments, step 215 may filter out substantially (most) lees from the mixture/solution. In some embodiments, step 215 may remove substantially (most) all microbe (e.g., yeast) cells from the mixture/solution. In some embodiments, step 215 may filter out substantially (most) undesired solids and/or particulates from the mixture/solution. In some embodiments, step 215 filtering may occur at a rate of about 1 minute per gallon to about 30 minutes per gallon, wherein “about” in this context may be plus or minus 30 seconds. In some embodiments, a filter size may be substantially a cheese cloth size. In some embodiments, step 215 may produce a seventh mixture. In some embodiments, step 215 may progress into step 217.

Continuing discussing FIG. 2, in some embodiments, step 217 may be a step of adjusting an alcohol (e.g., ethanol) content level in the result of step 215. In some embodiments, step 217 may comprise testing the result of step 215 for alcohol content. If the alcohol content is higher than a predetermined threshold, then water may be added to result of step 215 to dilute the alcohol content until the predetermined threshold is reached. In some embodiments, the finalized (target) alcohol content (e.g., ABV) of the beverage may be about 4% to about 8%, wherein “about” in this context may be plus or minus 0.5%. In some embodiments, step 217 may produce an eighth mixture. In some embodiments, step 217 may progress into step 219.

Continuing discussing FIG. 2, in some embodiments, step 219 may be a step of adding carbonation to the result of step 217. In some embodiments, step 219 may be accomplished by pumping carbon dioxide gas into the result of step 217 until a predetermined level of carbonation is reached. In some embodiments, step 219 may be accomplished by pumping nitrogen gas into the result of step 217 until a predetermined level of carbonation is reached. In some embodiments, step 219 may be a step of bottling the result of step 217; and then carbonating those filled bottles with carbon dioxide gas and/or with nitrogen gas to the predetermined level of carbonation. In some embodiments, step 219 may comprise adding one or more preservatives to the fermented cascara mixture/solution. In some embodiments, the one or more preservatives may be a sulfite (sulfite based), DMDC (dimethyl dicarbonate), combinations thereof, and/or the like. In some embodiments, step 219 may result in a sparkling cascara caffeinated mead, wherein the alcohol comes from fermentation of the cascara and the caffeine comes from the hydrated and steeped cascara. In some embodiments, step 219 may produce a ninth mixture. In some embodiments, step 219 may progress into step 221.

Continuing discussing FIG. 2, in some embodiments, step 221 may be a step of pasteurizing the result of step 219. In some embodiments, such pasteurization may stop any residual fermentation processes. In some embodiments, such pasteurization may sterilize the result of step 219. In some embodiments, step 221 may produce a tenth mixture.

In some embodiments, water used in method 200 may be a previously described and noted. For example, and without limiting the scope of the present invention, water may be purified, filtered, sterilized, WFI (water for injection), produced by reverse osmosis (RO), combinations thereof, and/or the like.

In some embodiments, the coffee fruit used in method 200 may be without coffee beans. In some embodiments, the coffee fruit used in method 200 may be “cascara.” In some embodiments, cascara may be coffee fruit, without coffee beans, that has been dried. In some embodiments, the drying processes used to produce the cascara may be from sunlight and/or air drying. In some embodiments, the drying processes used to produce the cascara may include artificial heating means to accelerate removal of moisture (water) from the coffee fruit, without beans, to be dried.

In some embodiments, the fermentation(s) discussed herein may use yeast(s) and/or bacteria. In some embodiments, the yeast(s) may be Lalvin (e.g., Lalvin EC-1118) and/or the like. In some embodiments, yeast nutrients may comprise diammonium phosphate, urea, combinations thereof, and/or the like.

In some embodiments, the caffeinated coffee fruit alcoholic beverage may comprise one or more of the following qualities: a bitterness (IBU) of about 284.34; a color (SRM) of golden amber; a carbonation level of 1.3 per volume; and/or an ABV of 7.32% (or an ABV of 4% to 8%).

The methods for producing the caffeinated coffee fruit alcoholic beverages discussed and disclosed herein are both structurally and functionally transformative, e.g., with diverse starting elements (e.g., coffee fruit, sugar, water, and microbial cultures—but with no released caffeine, no alcohol, and not any carbonation) being processed per the above steps so as to result in the caffeinated coffee fruit alcoholic beverage; wherein that final beverage may comprise alcohol, released caffeine in the liquid phase, and carbonation.

Note, as used herein within this disclosure, including this patent specification and within the claims, it is expressly included within the scope of this invention, that for each embodiment using “comprising” there is an additional embodiment wherein “comprising” is replaced with “consisting essentially of” and an additional embodiment wherein “comprising” is replaced with “consisting of.”

Note, as used herein within this disclosure, including this patent specification and within the claims, “comprising,” “consistent essentially of,” and “consisting of” are used as traditionally accepted within U.S. patent law, see e.g. MPEP section 2111.03.

A caffeinated coffee fruit alcoholic beverage and methods of manufacturing (producing) have been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method for producing a caffeinated coffee fruit alcoholic beverage comprising steps of:
(a) placing a predetermined amount of dried coffee fruit, without coffee beans, into a predetermined amount of hot water producing a first mixture;
(b) steeping the first mixture producing a second mixture comprising caffeine from the dried coffee fruit;
(c) adding in at least one sweetener to the second mixture to produce a third mixture;
(d) cooling the third mixture to room temperature producing a fourth mixture;
(e) adding at predetermined amount of at least one microbe to the fourth mixture producing a fifth mixture;
(f) fermenting the fifth mixture producing a sixth mixture that comprises ethanol and carbon dioxide from the fermentation and at least some of the caffeine;
(g) filtering the sixth mixture producing a seventh mixture;
(h) adjusting an ethanol content of the seventh mixture to a target ethanol content level producing an eighth mixture; and
(i) carbonating the eighth mixture producing a ninth mixture.

2. The method according to claim 1, wherein the at least one sweetener is sucrose and honey.

3. The method according to claim 1, wherein the at least one sweetener is dextrose and orange blossom honey.

4. The method according to claim 1, wherein the step (c) further comprises adding in at least one flavor to the second mixture producing the third mixture.

5. The method according to claim 4, wherein the at least one flavor is at least one natural flavor.

6. The method according to claim 4, wherein the at least one flavor is at least one herbal tea.

7. The method according to claim 4, wherein the at least one flavor is one or more of hibiscus herbal tea or lemon herbal tea.

8. The method according to claim 1, wherein prior to the step (h), the method comprises a step of determining the ethanol content of the seventh mixture by testing the ethanol content of the seventh mixture.

9. The method according to claim 1, wherein prior to the step (i), the method comprises a step of bottling the eighth mixture into a plurality of bottles, wherein the step (i) occurs in the plurality of bottles.

10. The method according to claim 1, wherein after the step (i), the method comprises a step of pasteurizing the ninth mixture producing a tenth mixture.

11. The method according to claim 1, wherein the at least one microbe is a type of yeast.

12. The method according to claim 1, wherein the type of yeast is champagne yeast.

13. The method according to claim 1, wherein in the step (a), the predetermined amount of dried coffee fruit, without the coffee beans, is present at about 150 grams to 500 grams per gallon of the hot water.

14. The method according to claim 1, wherein in the step (a), the hot water has a temperature of about 130 degrees Fahrenheit to about 212 degrees Fahrenheit.

15. The method according to claim 1, wherein in the step (b), the steeping occurs at temperatures of about 130 degrees Fahrenheit to about 212 degrees Fahrenheit; and wherein the steeping occurs from about 5 minutes to about 35 minutes.

16. The method according to claim 1, wherein the step (e) does not occur until the fourth mixture is at or below 80 degrees Fahrenheit.

17. The method according to claim 1, wherein in the step (e) the predetermined amount of at least one microbe is about 1 gram to about 5 grams per gallon.

18. The method according to claim 1, wherein the target ethanol content level is about 4% to about 8%, alcohol per volume.
